(19) United States
(12) Patent Application Publication
(10) Pub. No.: US 2025/0180283 A1
(43) Pub. Date: Jun. 5, 2025

(54) GAS TREATMENT SYSTEM AND SHIP INCLUDING SAME

(71) Applicants: HD KOREA SHIPBUILDING & OFFSHORE ENGINEERING CO., LTD., Gyeonggi-do (KR); HD HYUNDAI MIPO CO., LTD., Ulsan (KR)

(72) Inventors: Jae Jun LEE, Seoul (KR); Jong Wan PARK, Seoul (KR); Min Gyun PARK, Seoul (KR)

(21) Appl. No.: 18/845,338

(22) PCT Filed: Mar. 8, 2023
(86) PCT No.: PCT/KR2023/003197

§ 371 Date: Sep. 9, 2024

(30) Foreign Application Priority Data
Mar. 8, 2022 (KR) 10-2022-0029677
Oct. 27, 2022 (KR) 10-2022-0140734

(51) Int. Cl. F25J 1/00; F25J 1/02

(52) U.S. Cl. CPC F25J 1/0025; F25J 1/005; F25J 1/023; F25J 2270/14; F25J 2290/62; F25J 2290/72

(57) ABSTRACT

The present invention relates to a gas treatment system and a ship including the same, the gas treatment system including: a liquefied gas storage tank; a cooling device supercooling and returning a liquefied gas of the liquefied gas storage tank; and a main compressor pressurizing a boil off gas of the liquefied gas storage tank and supply it to a demander, wherein the cooling device includes: a supercooler for supercooling a liquefied gas with a refrigerant; and a gas heat exchanger cooling with a refrigerant at least one of a boil off gas discharged from the liquefied gas storage tank and transferred to the demander or a liquefied gas discharged from the liquefied gas storage tank and transferred to the demander, wherein the gas heat exchanger has a refrigerant flow path through which a refrigerant flows and a gas flow path through which at least one of a liquefied gas or a boil off gas flows.

### TECHNICAL FIELD

The present invention relates to a gas treatment system and a ship including the same.

### BACKGROUND ART

A ship is a means of transportation that sails the ocean, carrying a large amount of minerals, crude oil, natural gas, or thousands of containers, and it is made of steel and moves by the thrust generated by the rotation of a propeller while it is floating on the waterline due to buoyancy.

These ships generate thrust by driving an engine, and at this time, the engine typically uses gasoline or diesel to move a piston and rotates a crankshaft through the reciprocating motion of the piston, so that a shaft connected to the crankshaft is rotated to drive a propeller.

However, when heavy oil such as heavy fuel oil (HFO) or marine fuel oil (MFO) is used as propulsion fuel, environmental pollution caused by various harmful substances included in the exhaust gas is serious, so regulations on using heavy oil as fuel are being intensified, and the cost of satisfying these regulations is gradually increasing.

Accordingly, technology is being developed to use liquefied gases, such as liquefied natural gas (LNG) and liquefied petroleum gas (LPG), as fuel for ships, in replacement of gasoline or diesel.

Such liquefied gases are stored in a liquefied gas storage tank in a liquid state. LNG is reduced to 1/600 of its volume through liquefaction, and LPG is reduced to 1/260 of its volume through liquefaction for propane and 1/230 for butane, so they have the advantage of high storage efficiency.

However, since these liquefied gases are stored at extremely low temperatures below −50° C., there are problems such as the generation of a boil off gas (BOG) due to external heat penetration, and technologies for stably storing and treating liquefied gases are continuously being researched and developed.

### DISCLOSURE

### Technical Problem

The present invention was created to solve the above-described problems of the prior art, and an object of the present invention is to suppress a boil off gas (BOG) in a tank by injecting a supercooled liquefied gas into the tank.

The tasks of the present invention are not limited to the above-mentioned tasks, and other tasks that are not mentioned may be clearly understood by those of ordinary skill from the description below.

### Technical Solution

A gas treatment system according to one aspect of the present invention includes: a liquefied gas storage tank; a cooling device supercooling and returning a liquefied gas of the liquefied gas storage tank; and a main compressor pressurizing a BOG of the liquefied gas storage tank and supply it to a demander, wherein the cooling device includes: a supercooler for supercooling a liquefied gas with a refrigerant; and a gas heat exchanger cooling with a refrigerant at least one of a BOG discharged from the liquefied gas storage tank and transferred to the demander or a liquefied gas discharged from the liquefied gas storage tank and transferred to the demander, wherein the gas heat exchanger has a refrigerant flow path through which a refrigerant flows and a gas flow path through which at least one of a liquefied gas or a BOG flows.

Specifically, the gas treatment system may further include: a BOG line transferring a BOG from the liquefied gas storage tank to the demander; and a liquefied gas line transferring a liquefied gas from the liquefied gas storage tank to the demander, wherein the BOG line and the liquefied gas line may be provided to share the gas flow path of the gas heat exchanger.

Specifically, the gas treatment system may further include: a BOG bypass line branched off from the BOG line and bypassing the gas heat exchanger; a liquefied gas bypass line branched off from the liquefied gas line and bypassing the gas heat exchanger; and a control portion controlling a flow of the BOG bypass line and the liquefied gas bypass line.

Specifically, the cooling device may further include: a refrigerant line through which a refrigerant circulates, wherein the gas heat exchanger has a plurality of refrigerant flow paths connected to the refrigerant line, and the supercooler is provided on the refrigerant line interconnecting the plurality of refrigerant flow paths of the gas heat exchanger.

Specifically, the cooling device may further include: a refrigerant compressor compressing a refrigerant and transferring it to one of the refrigerant flow paths of the gas heat exchanger; and a refrigerant expander expanding a refrigerant discharged from one of the refrigerant flow paths of the gas heat exchanger and transferring it to the supercooler.

Specifically, the gas heat exchanger may include: a BOG heat exchanger cooling a refrigerant with a BOG discharged from the liquefied gas storage tank and transferred to the demander; and a liquefied gas heat exchanger cooling a refrigerant with a liquefied gas discharged from the liquefied gas storage tank and transferred to the demander, wherein the BOG heat exchanger and the liquefied gas heat exchanger are provided in series on the refrigerant line.

Specifically, the BOG heat exchanger may have the gas flow path shared by the BOG line and the liquefied gas line and is provided downstream of the liquefied gas heat exchanger based on a flow of liquefied gas.

Specifically, the cooling device may further include a refrigerant heat exchanger mutually heat-exchanging a refrigerant downstream of the refrigerant compressor and a refrigerant downstream of the supercooler, wherein the refrigerant heat exchanger may be provided in parallel with the gas heat exchanger.

Specifically, the gas heat exchanger may include: a BOG heat exchanger cooling a refrigerant with a BOG discharged from the liquefied gas storage tank and transferred to the demander; and a liquefied gas heat exchanger cooling a refrigerant with a liquefied gas discharged from the liquefied gas storage tank and transferred to the demander, and the cooling device may further include a refrigerant heat exchanger mutually heat-exchanging a refrigerant downstream of the refrigerant compressor and a refrigerant downstream of the supercooler, wherein the refrigerant heat exchanger and the liquefied gas heat exchanger may be provided in parallel on the refrigerant line, and the BOG heat exchanger and the liquefied gas heat exchanger or the refrigerant heat exchanger may be provided in series on the refrigerant line.

A ship according to one aspect of the present invention includes the gas treatment system.

### Advantageous Effects

The gas treatment system according to the present invention and the ship including the same can reduce a BOG generated in a tank by injecting a supercooled liquefied gas into the tank.

The effects of the present invention are not limited to the effects mentioned above, and other effects that are not mentioned will be clearly understood by those skilled in the art from the description of the claims.

### DESCRIPTION OF DRAWINGS

FIG. 1 shows a conceptual diagram of a gas treatment system according to Example 1 of the present invention.

FIG. 2 shows a conceptual diagram of a gas treatment system according to Example 2 of the present invention.

FIG. 3 shows a conceptual diagram of a gas treatment system according to Example 3 of the present invention.

FIG. 4 shows a conceptual diagram of a gas treatment system according to Example 4 of the present invention.

FIG. 5 shows a conceptual diagram of a gas treatment system according to Example 5 of the present invention.

FIG. 6 shows a conceptual diagram of a gas treatment system according to Example 6 of the present invention.

FIG. 7 shows a conceptual diagram of a cooling device according to Example 1 of the present invention.

FIG. 8 shows a conceptual diagram of a cooling device according to Example 2 of the present invention.

FIG. 9 shows a conceptual diagram of a cooling device according to Example 3 of the present invention.

FIG. 10 shows a conceptual diagram of a cooling device according to Example 4 of the present invention.

FIG. 11 shows a conceptual diagram of a gas treatment system according to Example 7 of the present invention.

FIG. 12 shows a conceptual diagram of a gas treatment system according to Example 8 of the present invention.

FIG. 13 shows a conceptual diagram of a gas treatment system according to Example 9 of the present invention.

FIG. 14 shows a conceptual diagram of a gas treatment system according to Example 10 of the present invention.

FIG. 15 shows a conceptual diagram of a gas treatment system according to Example 11 of the present invention.

FIG. 16 shows a conceptual diagram of a gas treatment system according to Example 12 of the present invention.

FIG. 17 shows a conceptual diagram of a gas treatment system according to Example 13 of the present invention.

FIG. 18 shows a conceptual diagram of a gas treatment system according to Example 14 of the present invention.

FIG. 19 shows a conceptual diagram of a gas treatment system according to Example 15 of the present invention.

FIG. 20 shows a conceptual diagram of a gas treatment system according to Example 15 of the present invention.

FIG. 21 shows a conceptual diagram of a gas treatment system according to Example 15 of the present invention.

FIG. 22 shows a conceptual diagram of a gas treatment system according to Example 16 of the present invention.

FIG. 23 shows a conceptual diagram of a gas treatment system according to Example 16 of the present invention.

FIG. 24 shows a conceptual diagram of a gas treatment system according to Example 17 of the present invention.

FIG. 25 shows a conceptual diagram of a gas treatment system according to Example 17 of the present invention.

FIG. 26 shows conceptual diagrams of gas treatment systems according to examples of the present invention.

FIG. 27 shows conceptual diagrams of gas treatment systems according to examples of the present invention.

FIG. 28 shows conceptual diagrams of gas treatment systems according to examples of the present invention.

FIG. 29 shows conceptual diagrams of gas treatment systems according to examples of the present invention.

FIG. 30 shows conceptual diagrams of gas treatment systems according to examples of the present invention.

### MODES OF THE INVENTION

The objects, specific advantages and novel features of the present invention will become more apparent from the following detailed description and preferred embodiments taken in conjunction with the accompanying drawings. In the present specification, when adding reference numerals to components in each drawing, it should be noted that identical components are given the same numerals as much as possible even if they are shown in different drawings. Additionally, in describing the present invention, when it is determined that a detailed description of related known technologies may unnecessarily obscure the gist of the present invention, the detailed description will be omitted.

Hereinafter, expressions such as first, second, and the like are intended in the present invention to refer to a plurality of specific features provided, and each expression may refer to any one of the plurality of features. When expressions such as first, second, and the like are not added, the feature may be a concept that encompasses all features to which expressions such as first, second, and the like are added.

The term “gas” used herein may be used to encompass all gaseous fuels that are generally stored in a liquid state, such as liquefied natural gas (LNG) or liquefied petroleum gas (LPG), ethylene, and ammonia, and even when they are not in a liquid state due to heating or pressurization, the may also be expressed as a liquefied gas for convenience. This may also be applied to a boil off gas (BOG).

In addition, the term “LNG” may be used to encompass not only a natural gas (NG) in a liquid state, but also an NG in a supercritical state or the like for convenience, and the term “BOG” may be used to encompass not only a gaseous BOG but also a liquefied BOG.

Hereinafter, it is to be noted that, high pressure (HP), low pressure (LP), high temperature, and low temperature are relative, do not represent absolute values, and may be used relatively according to each embodiment of the present invention.

The present invention includes a ship provided with a gas treatment system described below. At this time, the ship is a concept that includes a gas propulsion ship, a gas carrier, a floating storage and regasification unit (FSRU), a floating production storage and offloading (FPSO), a bunkering vessel, an offshore plant, and the like.

The present invention may be provided with pressure sensors (PTs), temperature sensors (TTs), flow sensors (FTs), and the like at appropriate positions without limitation, and the measurement values by each sensor may be used in various ways without limitation in the operation of the components described below.

In addition, in the drawings of the present invention, straight lines represent flow paths through which various fluids such as gas, refrigerant, heat, and non-explosive gas move, and may be interpreted as pipelines.

Hereinafter, preferred embodiments of the present invention will be described in detail with reference to the attached drawings.

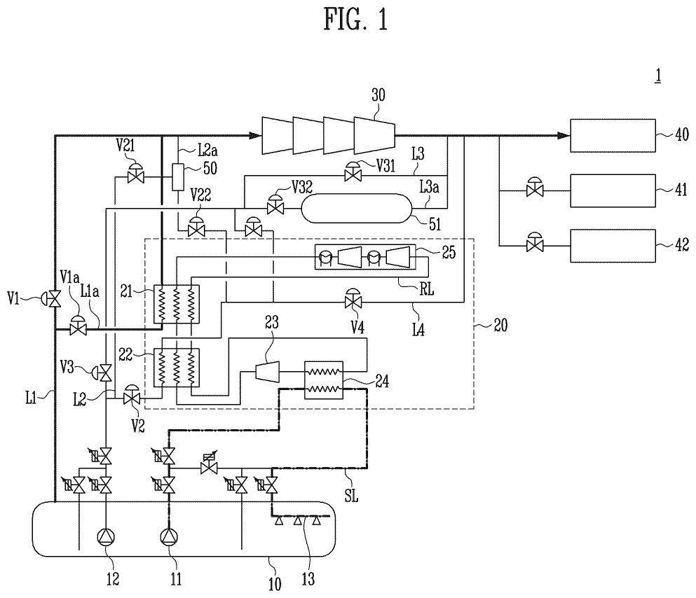

FIG. 1 shows a conceptual diagram of a gas treatment system according to Example 1 of the present invention.

Referring to FIG. 1, a gas treatment system 1 according to one embodiment of the present invention may include a liquefied gas storage tank 10, a cooling device 20, a main compressor 30, and a demander 40.

A liquefied gas storage tank 10 stores a liquefied gas to be supplied to a demander 40. At this time, the liquefied gas storage tank 10 may store a liquefied gas in a liquid state and may have a pressure tank form. A liquefied gas storage tank 10 may be provided in a plural number, and a plural number or more may be disposed side by side.

The liquefied gas storage tank 10 has an insulated structure, but when heat enters into the liquefied gas storage tank 10 from the outside, a liquefied gas stored in the liquefied gas storage tank 10 becomes warm, and a part of it is evaporated. This evaporated liquefied gas is a BOG that is stored in a space above a liquid level of a liquefied gas stored in the liquefied gas storage tank 10.

The liquefied gas storage tank 10 may be provided with a BOG line L1 that may extract a BOG stored in an upper space within the liquefied gas storage tank 10 to the outside of the liquefied gas storage tank 10, at an upper portion of the liquefied gas storage tank 10. The BOG line L1 may be branched in the middle and connected to a BOG branch line L1a, and a BOG heat exchanger 21 may be provided on the BOG branch line L1a.

In other words, the BOG line L1 may bypass the BOG heat exchanger 21, and the BOG branch line L1a may pass through the BOG heat exchanger 21.

For reference, a component which implements heat exchange but in which a BOG or liquefied gas flows, such as a BOG heat exchanger 21, may be defined as a gas heat exchanger below.

A BOG line L1 and a BOG branch line L1a are provided with valves V1 and V1a for temperature control. The degree of opening of the valves V1 and V1a may be adjusted according to the temperature required by a main compressor 30 and the temperature of a BOG. For example, when the temperature of the BOG is higher than the temperature required by a main compressor 30, the BOG valve V1a provided on the BOG branch line L1a may be closed, and when the temperature of the BOG is lower than the temperature required by a main compressor 30, the BOG valve V1 provided on the BOG line L1 may be closed.

A BOG is transferred to a demander 40 through a BOG line L1 or a BOG branch line L1a. When a BOG passes through a BOG heat exchanger 21, the BOG transferred to a demander 40 may be heated, and at the same time, a refrigerant within a refrigerant line RL may be cooled.

When the internal pressure of a liquefied gas storage tank 10 is high, a BOG may be transferred to a demander 40 so that the BOG may be consumed at the demander 40, thereby lowering the pressure inside the liquefied gas storage tank 10.

A gas treatment system 1 according to one embodiment of the present invention may include a control portion (not shown) controlling a BOG to pass through a BOG heat exchanger 21 or a liquefied gas to pass through a liquefied gas heat exchanger 22 according to the internal pressure of a liquefied gas storage tank 10.

When a large amount of BOG is generated in a liquefied gas storage tank 10 and the pressure of the liquefied gas storage tank 10 is high, the pressure of the liquefied gas storage tank 10 may be lowered by consuming the BOG. At this time, the control portion may lower the temperature of a refrigerant by transferring the BOG to a BOG heat exchanger 21 in the process of consuming the BOG. Specifically, a control portion opens a BOG branch valve V1a to transfer the BOG to the BOG heat exchanger 21.

On the other hand, when a large amount of BOG is not generated in a liquefied gas storage tank 10 and thus the pressure of the liquefied gas storage tank 10 is not high, a liquefied gas may be vaporized and supplied to a demander 40. At this time, the control portion can lower the temperature of a refrigerant by transferring the liquefied gas to a liquefied gas heat exchanger 22 in the process of supplying the liquefied gas to the demander 40. Specifically, the control portion opens a liquefied gas branch valve V2 to transfer the BOG to the liquefied gas heat exchanger 22.

A demander 40 may be a dual fuel (DF) engine as a main propulsion device. When it is described in the present specification that a liquefied gas is transferred to a demander 40, this may include a liquefied gas being transferred to a power generation engine 41 that generates electricity required within a ship or a gas combustion unit (GCU) 42 that burns a BOG.

The BOG heat exchanger 21 may exchange heat between a refrigerant and a BOG of a liquefied gas storage tank 10, and a liquefied gas heat exchanger 22 may exchange heat between a refrigerant and a liquefied gas of the liquefied gas storage tank 10.

In addition, a BOG heat exchanger 21 and a liquefied gas heat exchanger 22 may be combined type heat exchangers. In other words, a BOG heat exchanger 21 may heat-exchange a refrigerant and a BOG of a liquefied gas storage tank 10 while simultaneously allowing heat exchange to occur between refrigerants. Similarly, a liquefied gas heat exchanger 22 may heat-exchange a refrigerant and a liquefied gas of a liquefied gas storage tank 10 while simultaneously allowing heat exchange to occur between refrigerants.

A liquefied gas storage tank 10 may be provided with a pump 11 and 12, and a liquefied gas stored in a liquefied gas storage tank 10 may be removed through a pump 11 and 12. A pump 11 and 12 may be provided to be immersed in a liquefied gas stored inside a liquefied gas storage tank 10 or may be provided on the outside of a liquefied gas storage tank 10.

When a pump 11 and 12 is provided on the outside of a liquefied gas storage tank 10, the pump 11 and 12 may be installed at a lower position than the liquefied gas storage tank 10. In some cases, a pump 11 and 12 may not be able to pump a liquefied gas when the level of the liquefied gas is low. However, when a pump 11 and 12 is installed at a lower position than a liquefied gas storage tank 10, a liquefied gas may be prevented from falling below a certain level, and it may be prevented that the liquefied gas level is low to the extent that pumping is impossible.

A pump 11 and 12 may be a boosting pump installed inside a liquefied gas storage tank 10 and immersed in a liquefied gas.

A first pump 11 may transfer a liquefied gas to a supercooler 24 through a supercooler line SL. A liquefied gas supercooled through a supercooler 24 is circulated to a liquefied gas storage tank 10 through an injection device 13. Preferably, a circulated liquefied gas may be injected into a liquefied gas storage tank 10 to cool the liquefied gas inside the liquefied gas storage tank 10. By cooling a liquefied gas inside a liquefied gas storage tank 10, the generation of a BOG inside the liquefied gas storage tank 10 may be suppressed. Although not shown in the drawing, a circulated liquefied gas may be injected close to the bottom of a liquefied gas storage tank 10.

A second pump 12 may transfer a liquefied gas to a demander 40. A second pump 12 may transfer a liquefied gas to a demander 40 through a liquefied gas line L2 connected to the front end of a main compressor 30 by bypassing a liquefied gas heat exchanger 22.

In addition, a second pump 12 may allow a liquefied gas to pass through a liquefied gas heat exchanger 22 and be transferred to a demander 40. A second pump 12 may transfer a liquefied gas to a demander 40 through a liquefied gas mixing line L2a that passes through a liquefied gas heat exchanger 22 and is connected to the front end of a main compressor 30, a liquefied gas heating line L3a that passes through a liquefied gas heat exchanger 22 and passes through a liquefied gas heater 51, a liquefied gas bypass line L3 that passes through a liquefied gas heat exchanger 22 and bypasses a liquefied gas heater 51, or a liquefied gas transfer line L4 that passes through a liquefied gas heat exchanger 22 and is connected to the rear end of a main compressor 30.

When a liquefied gas transferred to a demander 40 passes through a liquefied gas heat exchanger 22, the liquefied gas transferred to the demander 40 may be heated, and simultaneously, a refrigerant within a refrigerant line RL may be cooled.

When the internal pressure of a liquefied gas storage tank 10 is not high and a liquefied gas needs to be supplied to a demander 40, a liquefied gas in a liquid state may be supplied to a liquefied gas heater to vaporize the liquefied gas and transfer the BOG to the demander 40.

One or more liquefied gas storage tanks 10 may be provided, and one of the liquefied gas storage tanks 10 may be a pressurized tank. A BOG generated from a plurality of liquefied gas storage tanks 10 may be stored in a pressurized tank, and the BOG may be pressurized within the pressurized tank. The BOG may be supplied to a demander 40 using the pressure of the pressurized tank without providing additional pressure to the pressurized tank. Of course, a BOG of a liquefied gas storage tank 10 that is not a pressurized tank may also be transferred to a demander 40 together with the BOG of the pressurized tank.

Hereinafter, the same content as described through FIG. 1 will be replaced with the content of the previous embodiment.

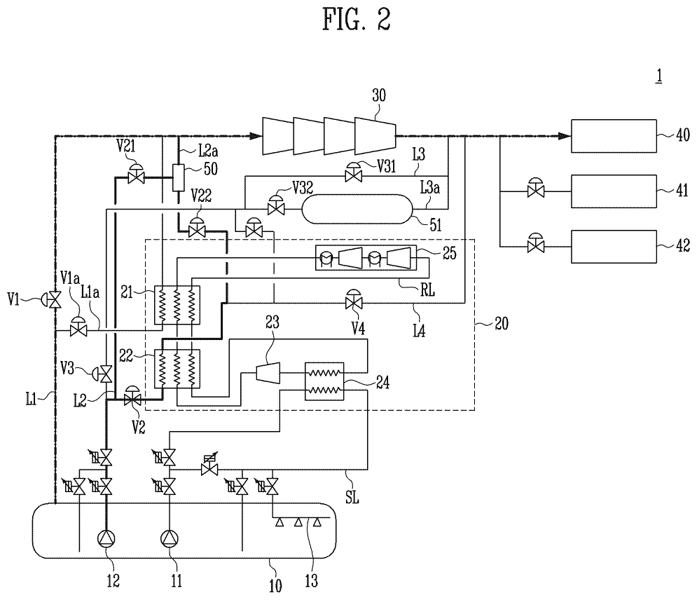

FIG. 2 shows a conceptual diagram of a gas treatment system according to Example 2 of the present invention.

Referring to FIG. 2, when the internal pressure of a liquefied gas storage tank 10 is low, a liquid liquefied gas of the liquefied gas storage tank 10 may be supplied to a demander 40 by passing through a liquefied gas heat exchanger 22. A part of the liquefied gas that has passed through the liquefied gas heat exchanger 22 may be supplied to a demander 40 by passing through a liquefied gas line L2 connected to the front end of a main compressor 30 by bypassing the liquefied gas heat exchanger 22 depending on the temperature of the front end of the main compressor 30.

In other words, a liquefied gas of a liquid phase may be vaporized in a liquefied gas heat exchanger 22 and supplied to the front end of a main compressor 30. At this time, in order to meet the temperature required by the main compressor 30, a part of the liquefied gas may bypass the liquefied gas heat exchanger 22.

A liquefied gas that has passed through a liquefied gas heat exchanger 22 and a liquefied gas that has bypassed a liquefied gas heat exchanger 22 may be mixed in a mixer 50.

To control the temperature of a liquefied gas in this way, a first liquefied gas mixing valve V21 and a second liquefied gas mixing valve V22 may be provided. A control portion may open a first liquefied gas mixing valve V21 to lower the temperature of a liquefied gas supplied to the front end of a main compressor 30, and a liquefied gas that has not passed through a liquefied gas heat exchanger 22 may be supplied through a liquefied gas line L2.

In a situation where a cooling device 20 does not need to be operated, a liquefied gas branch valve V2 may be closed and a liquefied gas supply valve V3 may be open, in which case a liquefied gas may be transferred through a liquefied gas bypass line L3 or a liquefied gas heating line L3a by bypassing a liquefied gas heat exchanger 22.

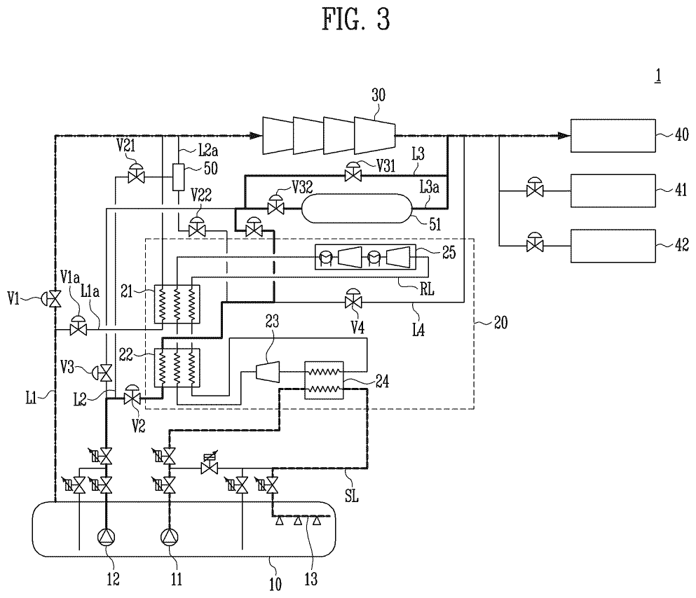

FIG. 3 shows a conceptual diagram of a gas treatment system according to Example 3 of the present invention.

Referring to FIG. 3, when the internal pressure of a liquefied gas storage tank 10 is low, a liquid liquefied gas of the liquefied gas storage tank 10 may pass through a liquefied gas heat exchanger 22. Thereafter, in order that the temperature of the liquefied gas may match the temperature of the rear end of a main compressor 30, depending on the temperature of the rear end of the main compressor 30, the liquefied gas may be controlled to be supplied to a demander 40 through a liquefied gas heating line L3a that passes through a liquefied gas heat exchanger 22 and passes through a liquefied gas heater 51, or the liquefied gas may be controlled to be supplied to a demander 40 through a liquefied gas bypass line L3 that passes through a liquefied gas heat exchanger 22 and bypasses a liquefied gas heater 51.

Here, the liquefied gas may be supplied directly to a demander 40 without passing through the main compressor 30. Since the liquefied gas does not pass through the main compressor 30, the temperature does not rise in the main compressor 30. Therefore, in order to meet the temperature conditions required by a demander 40, the liquefied gas heater 51 may adjust the temperature to match the temperature at the rear end of the main compressor 30.

At this time, when the temperature of the liquefied gas passing through the liquefied gas heater 51 becomes higher than the temperature condition required by a demander 40, a part of the liquefied gas may be supplied to the demander 40 through a liquefied gas bypass line L3 that bypasses the liquefied gas heater 51.

A liquefied gas bypass valve V31 and a liquefied gas heating valve V32 may be provided to control a flow path of a liquefied gas. The control portion may control a liquefied gas bypass valve V31 to open in order to lower the temperature of a liquefied gas supplied to the rear end of a main compressor 30, and a part of the liquefied gas may be supplied through a liquefied gas bypass line L3.

In this way, when a liquefied gas is directly supplied to a demander 40 through a liquefied gas heater 51, a main compressor 30 may not be operated, or the load on the main compressor 30 may be reduced, so the power used in the gas treatment system 1 may be reduced.

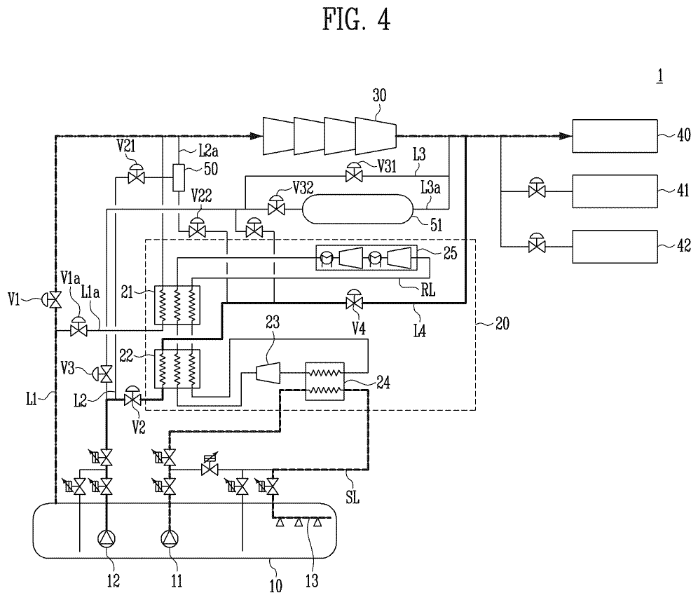

FIG. 4 shows a conceptual diagram of a gas treatment system according to Example 4 of the present invention.

Referring to FIG. 4, when sufficient heating is performed in a liquefied gas heat exchanger 22 so that a liquefied gas meets the temperature condition required by a demander 40, the liquefied gas may bypass a liquefied gas heater 51. A liquefied gas of a liquid phase in a liquefied gas storage tank 10 may be transferred to a demander 40 through a liquefied gas transfer line L4 that passes through a liquefied gas heat exchanger 22 and is connected to the rear end of a main compressor 30. In this case, a liquefied gas transfer valve V4 provided on the liquefied gas transfer line L4 may be opened.

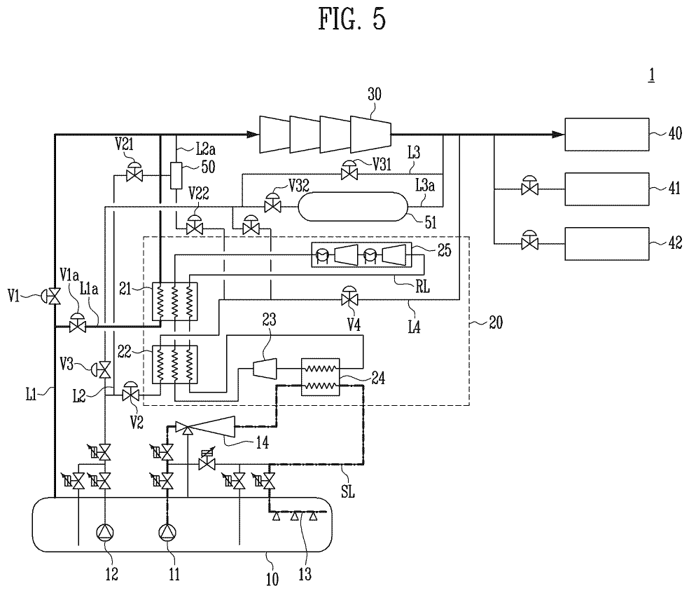

FIG. 5 shows a conceptual diagram of a gas treatment system according to Example 5 of the present invention.

Referring to FIG. 5, a supercooling line SL may be provided with an ejector 14. The ejector 14 may be provided at the front end of a supercooler 24 and may suck in a BOG using a liquefied gas entering into the supercooler 24 as a driving force, mix the BOG and the liquefied gas, and circulate them to a liquefied gas storage tank. In this process, the BOG in the liquefied gas storage tank 10 may be liquefied and recovered.

Although not shown in the drawing, an ejector 14 may be provided at the rear end of a supercooler 24, in which case a supercooled liquefied gas may be used as a driving force to suck in and condense a BOG in a liquefied gas storage tank 10.

When an ejector 14 is installed at the front end of a supercooler 24, the mixing ratio of a BOG increases, and the volume of a fluid in which a liquefied gas and the BOG are mixed increases due to the increased ratio of the BOG, so the size of the supercooler 24 for cooling the mixed fluid may also increase. Therefore, an ejector 14 is preferably installed at the rear end of a supercooler 24 in consideration of the installation cost of the supercooler 24 and the efficiency of the installation space.

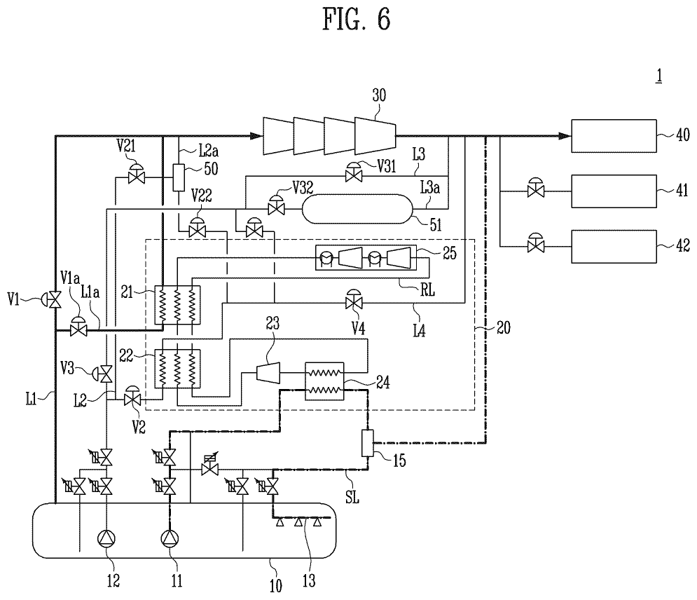

FIG. 6 shows a conceptual diagram of a gas treatment system according to Example 6 of the present invention.

Referring to FIG. 6, a BOG condenser 15 may be provided at the rear end of a supercooler 24. The rear end of a main compressor 30 and the rear end of the supercooler 24 may be connected to each other, and the BOG condenser 15 may liquefy a BOG by mixing a part of the BOG supplied from the rear end of the main compressor 30 with a supercooled liquefied gas. Although not shown in the drawing, a BOG condenser 15 may also be provided at the front end of a supercooler 24. In addition, heat exchange may occur between a BOG flowing from the rear end of a main compressor 30 to the rear end of a supercooler 24 and a BOG flowing through a BOG line L1.

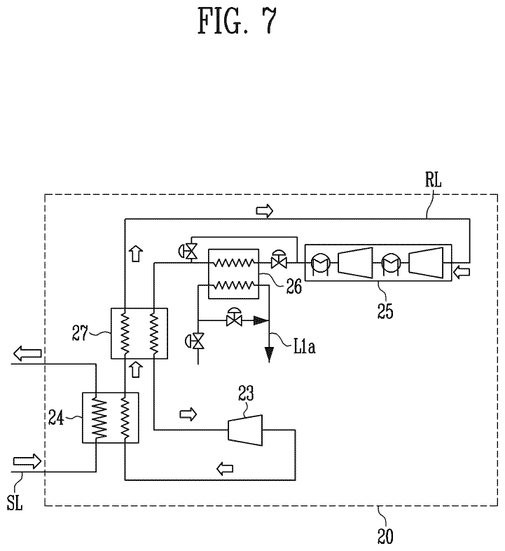

FIG. 7 shows a conceptual diagram of a cooling device according to Example 1 of the present invention.

Referring to FIG. 7, a cooling device 20 includes a supercooling line SL and a refrigerant line RL. A supercooling line SL is connected to a liquefied gas storage tank 10, so a liquefied gas discharged from a liquefied gas storage tank 10 flows through the supercooling line SL. A refrigerant for supercooling a liquefied gas flows through a refrigerant line RL.

A refrigerant line RL may be provided with a refrigerant expander 23, a supercooler 24, a refrigerant compressor 25, a refrigerant cooler 26, and a refrigerant heat exchanger 27. A refrigerant cooler 26 and a refrigerant heat exchanger 27 may be connected in series. The refrigerant cooler 26 may be provided downstream of a refrigerant compressor 25, and the refrigerant heat exchanger 27 may be provided downstream of the refrigerant cooler 26.

A refrigerant is compressed to high pressure in a refrigerant compressor 25. Here, the refrigerant compressor 25 may have a structure in which a compression stage and a cooler are connected in multiple stages.

A refrigerant may be guided to a refrigerant cooler 26 after being compressed to high pressure in a refrigerant compressor 25, and may heat-exchange with a BOG or a liquefied gas transferred to a demander 40, thereby removing the heat of compression.

A high-pressure refrigerant cooled in a refrigerant cooler 26 may be guided to a refrigerant heat exchanger 27, and may heat-exchange with a refrigerant that has passed through a supercooler 24.

Thereafter, the refrigerant is guided to a refrigerant expander 23 and decompressed in the refrigerant expander 23 to become a low-temperature, low-pressure refrigerant. The refrigerant may be guided to a supercooler 24 and may heat-exchange with a liquefied gas that is discharged from a liquefied gas storage tank 10 and circulated to the liquefied gas storage tank 10.

A refrigerant undergoes heat exchange in a supercooler 24 so that its temperature is increased, and the relatively high-temperature refrigerant is guided to a refrigerant compressor 25 and compressed to a high pressure in the refrigerant compressor 25.

A refrigerant line RL may be branched at the bottom of a refrigerant compressor 25 so that a refrigerant may bypass a refrigerant cooler 26. Depending on the temperature of a refrigerant introduced into a refrigerant cooler 26, the temperature of a BOG, the temperature of a liquefied gas, or the like, a part of the refrigerant may bypass the refrigerant cooler 26, and the flow rate of the refrigerant may be controlled. Similarly, depending on the temperature of a refrigerant introduced into a refrigerant cooler 26, the temperature of a BOG, the temperature of a liquefied gas, or the like, the BOG or the liquefied gas may bypass the refrigerant cooler 26, and the flow rate of the BOG or the liquefied gas may be controlled.

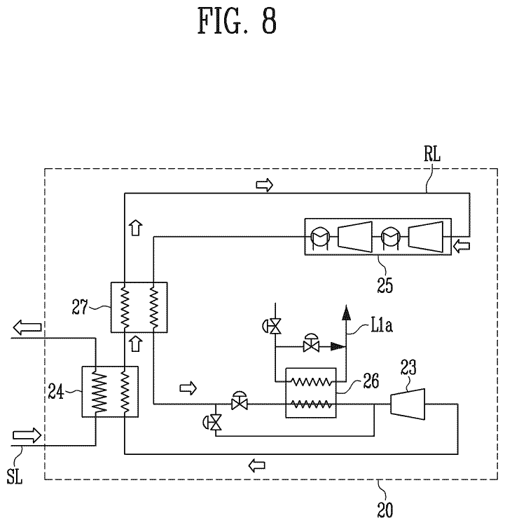

FIG. 8 shows a conceptual diagram of a cooling device according to Example 2 of the present invention.

Referring to FIG. 8, a cooling device 20 according to Example 2 may include a refrigerant cooler 26 and a refrigerant heat exchanger 27 in an order different from that of FIG. 7, so that the refrigerant heat exchanger 27 may be provided downstream of a refrigerant compressor 25, and the refrigerant cooler 26 may be provided downstream of the refrigerant heat exchanger 27.

After a refrigerant is compressed to a high pressure in a refrigerant compressor 25, it may be guided to a refrigerant heat exchanger 27, where it heat-exchanges with a refrigerant that has passed through a supercooler 24, and then it is guided to a refrigerant cooler 26, where it may heat-exchange with a BOG or a liquefied gas transferred to a demander 40.

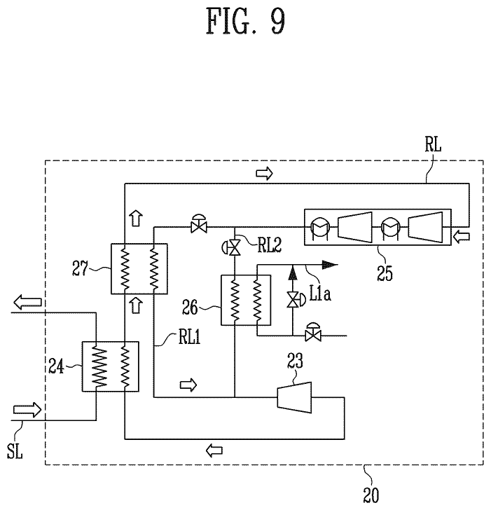

FIG. 9 shows a conceptual diagram of a cooling device according to Example 3 of the present invention.

Referring to FIG. 9, a refrigerant cooler 26 and a refrigerant heat exchanger 27 may be connected in parallel. A refrigerant line RL may be branched into a first refrigerant line RL1 connected to a refrigerant heat exchanger 27 downstream of a refrigerant compressor 25 and a second refrigerant line RL2 connected to a refrigerant cooler 26.

A refrigerant may be guided to a refrigerant cooler 26 after being compressed to a high pressure in a refrigerant compressor 25, and may heat-exchange with a BOG or a liquefied gas transferred to a demander 40, thereby removing the heat of compression, and a refrigerant may be guided to a refrigerant heat exchanger 27 to be cooled by heat-exchanging with a refrigerant that has passed through a supercooler 24.

Thereafter, the refrigerant is guided to a refrigerant expander 23 and decompressed in the refrigerant expander 23 to become a low-temperature, low-pressure refrigerant. The refrigerant may be guided to a supercooler 24 and may heat-exchange with a liquefied gas that is discharged from a liquefied gas storage tank 10 and circulated to the liquefied gas storage tank 10.

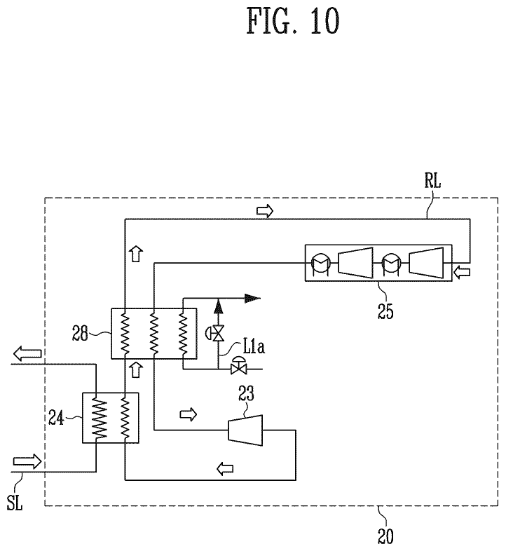

FIG. 10 shows a conceptual diagram of a cooling device according to Example 4 of the present invention.

Referring to FIG. 10, a cooling device 20 includes an integrated heat exchanger 28. An integrated heat exchanger 28 may have an integrated function of a refrigerant cooler 26 and the refrigerant heat exchanger 27.

A refrigerant may be guided to an integrated heat exchanger 28 after being compressed to a high pressure in a refrigerant compressor 25, and may heat-exchange with a BOG or a liquefied gas transferred to a demander 40, thereby removing the heat of compression, and simultaneously, it may be cooled by heat-exchanging with a refrigerant that has passed through a supercooler 24.

Thereafter, the refrigerant is guided to a refrigerant expander 23 and decompressed in the refrigerant expander 23 to become a low-temperature, low-pressure refrigerant. The refrigerant may be guided to a supercooler 24 and may heat-exchange with a liquefied gas that is discharged from a liquefied gas storage tank 10 and circulated to the liquefied gas storage tank 10.

FIGS. 7 to 9 show a refrigerant cooler 26 connected to a BOG branch line L1a, and FIG. 10 shows an integrated heat exchanger 28 connected to a BOG branch line L1a, but the refrigerant cooler 26 or the integrated heat exchanger 28 may be connected to liquefied gas lines L2a, L3a, and LA. When a refrigerant cooler 26 or an integrated heat exchanger 28 is connected to a BOG branch line L1a, a refrigerant may be cooled by a BOG, and when a refrigerant cooler 26 or an integrated heat exchanger 28 is connected to liquefied gas lines L2a, L3a, and L4, a refrigerant may be cooled by a liquefied gas.

It is obvious that the cooling device 20 according to one embodiment of FIGS. 7 to 10 may be applied to the gas treatment system 1 according to one embodiment of FIGS. 1 to 6.

In this way, the gas treatment system 1 according to the present invention can supercool a liquefied gas using a refrigerant and circulate the supercooled liquefied gas into a tank to reduce a BOG gas generated in the tank.

In addition, the gas treatment system 1 according to the present invention may cool a refrigerant using the cold heat of a BOG, or using the cold heat of a liquefied gas, depending on the internal pressure of a liquefied gas storage tank 10. In addition, when a refrigerant is cooled using the cold heat of a BOG, the gas treatment system 1 according to the present invention may control the BOG to bypass a BOG heat exchanger 21 depending on the temperature of the front end of a main compressor 30.

In addition, when a refrigerant is cooled using the cold heat of a liquefied gas, the gas treatment system 1 according to the present invention may control the liquefied gas to bypass a liquefied gas heat exchanger 22 depending on the temperature of the front end of a main compressor 30, or may control the liquefied gas to bypass a liquefied gas heater 51 depending on the temperature of the rear end of the main compressor 30.

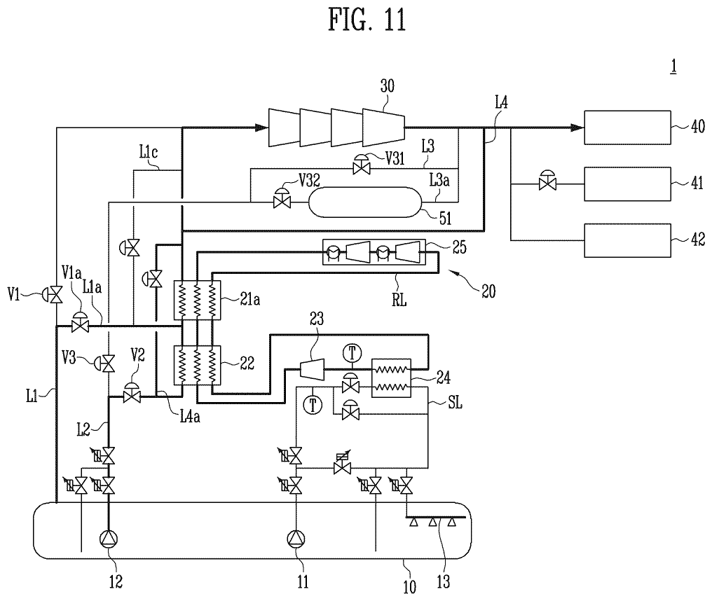

FIG. 11 shows a conceptual diagram of a gas treatment system according to Example 7 of the present invention.

Hereinafter, the differences between the present embodiment and the previous embodiments will be mainly explained, and any parts that are omitted will be replaced with the previous content. This applies to all embodiments included in the present invention.

Referring to FIG. 11, the gas treatment system 1 according to Example 7 of the present invention includes a cooling device 20 that implements supercooling of a liquefied gas, similar to the previous embodiments.

Specifically, the cooling device of the present embodiment includes a refrigerant expander 23, a supercooler 24, a refrigerant compressor 25, and the like. These components may be disposed in series or in parallel on a refrigerant line RL that forms a closed loop.

A refrigerant expander 23 is provided on a refrigerant line RL and expands a refrigerant discharged from a refrigerant heat exchanger 27 and transfers it to a supercooler 24. For reference, the path through which a refrigerant is transferred from a refrigerant heat exchanger 27 to a refrigerant expander 23 may be different from the path through which a refrigerant is introduced a refrigerant heat exchanger 27 from a refrigerant compressor 25, which will be described later.

A refrigerant expander 23 may be an expansion turbine, a depressurizing valve, an expander, or the like, and other non-limiting depressurization/expansion means may be used. In addition, a refrigerant expander 23 may be connected to a refrigerant compressor 25 to form a compander.

A refrigerant expander 23 expands a refrigerant between a refrigerant heat exchanger 27 and a supercooler 24, thereby lowering the pressure of the refrigerant and at the same time, lowering the temperature of the refrigerant. A refrigerant that has been depressurized and cooled by a refrigerant expander 23 may be used to supercool a liquefied gas in a supercooler 24.

A supercooler 24 supercools a liquefied gas with a refrigerant. A supercooler 24 may be provided on a supercooling line SL and a refrigerant line RL and has a structure in which one flow path is connected to the supercooling line SL and the other flow path is connected to the refrigerant line RL.

A supercooler 24 receives a liquefied gas discharged from a liquefied gas storage tank 10 by a first pump 11 or the like, and also receives a depressurized refrigerant from a refrigerant expander 23. A supercooler 24 may supercool a liquefied gas discharged from a liquefied gas storage tank 10 with a refrigerant depressurized in a refrigerant expander 23.

A liquefied gas supercooled by a supercooler 24 is returned to the inside of a liquefied gas storage tank 10 through an injection device 13 provided in the form of a spray or pipe. Through this, the generation of a BOG in the liquefied gas storage tank 10 may be suppressed.

A supercooling line SL connected to a supercooler 24 may be provided to allow a liquefied gas to flow between a pump and an injection device 13. However, a supercooling line SL may allow at least a part of a liquefied gas discharged from a liquefied gas storage tank 10 to bypass a supercooler 24.

A pump that transfers a liquefied gas to a supercooling line SL may be a first pump 11 or a second pump 12, and in the case of the present embodiment, a pump for supercooling and a pump for supply to a demander 40 may be integrated.

In other words, the present embodiment may transfer a liquefied gas to a supercooler 24 or a demander 40 using a single pump. In this case, since various valves are provided on a liquefied gas line L2, the flow rate of a liquefied gas transferred to a supercooler 24 or a demand source 40 may be adjusted. The control of the flow rate of a liquefied gas through the control of the valve opening degree may be achieved by the above-mentioned control portion.

A refrigerant compressor 25 is provided on a refrigerant line RL and compresses a refrigerant and transfers it to one of the flow paths of a gas heat exchanger 21a and 22. The gas heat exchanger of the present embodiment will be described in detail below.

A refrigerant compressor 25 may have a structure in which compression stages and coolers are alternately provided, and at least two compression stages may be used. Of course, the number of compression stages is not limited. In addition, it has been explained that in a refrigerant compressor 25, compression stages may also be connected integrally with a refrigerant expander 23 through a single shaft.

The present embodiment is similar to Example 1 in that a BOG heat exchanger 21a and a liquefied gas heat exchanger 22 are provided as gas heat exchangers, but the BOG heat exchanger 21a may be different from that of Example 1.

The BOG heat exchanger 21a of the present embodiment may cool a refrigerant through a BOG while including a plurality of flow paths for heat exchange between refrigerants. Furthermore, a BOG heat exchanger 21a may also utilize the cold heat of a liquefied gas to cool a refrigerant.

However, a BOG heat exchanger 21a is not further provided with an exclusive flow path through which a liquefied gas flows, in addition to a refrigerant flow path and a BOG flow path. A BOG heat exchanger 21a of the present embodiment may allow a liquefied gas to flow through a flow path through which a BOG flows, as needed.

In other words, a BOG heat exchanger 21a may cool a refrigerant using at least one of a BOG discharged from a liquefied gas storage tank 10 and transferred to a demander 40 or a liquefied gas discharged from a liquefied gas storage tank 10 and transferred to a demander 40.

In particular, a BOG heat exchanger 21a may have a refrigerant flow path through which a refrigerant flows and a gas flow path through which at least one of a liquefied gas and a BOG flows. At this time, the gas flow path may be connected to both a BOG line L1 and a liquefied gas line L2.

In other words, a BOG line L1 and a liquefied gas line L2 are provided to share a gas flow path of a BOG heat exchanger 21a. Therefore, in a BOG heat exchanger 21a, either BOG or a liquefied gas may alternatively flow through a single flow path.

A BOG line L1 may be provided to transfer a BOG to a demander 40 from a liquefied gas storage tank 10, but allow the BOG to bypass a BOG heat exchanger 21a to cool a refrigerant. Of course, a BOG line L1 may be provided so that at least a part of a BOG bypasses a BOG heat exchanger 21a. For example, a BOG line L1 may be provided with a BOG bypass line L1c that is branched off from the upstream of a BOG heat exchanger 21a and joins a BOG line L1 between a BOG heat exchanger 21a and a main compressor 30, and a BOG bypass line L1c may be provided with a BOG bypass valve (reference numeral not shown). In addition, a BOG bypass valve may be controlled by a control portion.

A BOG may be transferred to a BOG heat exchanger 21a as needed to cool a refrigerant heated by the heat of compression while being compressed by a refrigerant compressor 25. A BOG may also cool both a refrigerant before compression and a refrigerant after compression.

In addition, a liquefied gas may also be transferred to a BOG heat exchanger 21a and used to cool a refrigerant. A liquefied gas is transferred from a liquefied gas storage tank 10 to a demander 40 along a liquefied gas line L2. At least a part of the liquefied gas may be transferred to a demander 40 through a liquefied gas heater 51 or the like, and a part of the remainder may pass through a liquefied gas heat exchanger 22 and a BOG heat exchanger 21a.

A liquefied gas line L2 is provided to pass through a BOG heat exchanger 21a, and in this case, the liquefied gas line L2 and a BOG gas line L1 may be joined upstream of a gas flow path of the BOG gas heat exchanger 21a.

Therefore, a gas flow path of a BOG heat exchanger 21a may be connected to a liquefied gas line L2 and also to a BOG line L1, but either a liquefied gas or a BOG may alternatively flow in the gas flow path.

The downstream of a gas flow path of a BOG heat exchanger 21a may be branched into a BOG line L1 and a liquefied gas line L2 (particularly, a liquefied gas transfer line L4). At this time, the branching of the gas downstream of the gas flow path may be controlled by a control portion through various valves illustrated or omitted in the drawing.

For example, when a liquefied gas flowing along a liquefied gas line L2 is introduced into a BOG heat exchanger 21a, the liquefied gas may be transferred to a demander 40 along the liquefied gas line L2 downstream of the BOG heat exchanger 21a.

On the other hand, when a BOG flowing along a BOG line L1 is introduced into a BOG heat exchanger 21a, the BOG downstream of the BOG heat exchanger 21a may be introduced into a main compressor 30 along the BOG line L1 and then transferred to a demander 40.

A gas flow path of a BOG heat exchanger 21a may have a structure in which gases of different pressures may flow. A BOG flowing into a gas flow path through a BOG line L1 may be in a low-pressure state with a pressure to be introduced into a main compressor 30, whereas a liquefied gas flowing into the gas flow path through a liquefied gas line L2 may be in a high-pressure state with a pressure to be mixed with the BOG downstream of the main compressor 30. Accordingly, a gas flow path of a BOG heat exchanger 21a may be provided in such a way that either a BOG at a relatively low pressure or a liquefied gas at a relatively high pressure may alternatively flow.

A liquefied gas line L2 may allow a liquefied gas to bypass a BOG heat exchanger 21a. To this end, a liquefied gas bypass line L4a is branched off from the liquefied gas line L2 upstream of the BOG heat exchanger 21a, and the liquefied gas bypass line L4a may be joined to the liquefied gas line L2 downstream of the BOG heat exchanger 21a.

A liquefied gas bypass line L4a may be branched off from a liquefied gas line L2 upstream of a liquefied gas heat exchanger 22 and may be joined to the liquefied gas line L2 downstream of a BOG heat exchanger 21a. Therefore, a liquefied gas may bypass both a liquefied gas heat exchanger 22 and a BOG heat exchanger 21a simultaneously through a liquefied gas bypass line L4a.

Of course, a liquefied gas bypass line L4a may be provided to implement a bypass of a liquefied gas for each liquefied gas heat exchanger 22 and BOG heat exchanger 21a.

The liquefied gas bypass and the above-mentioned BOG bypass are controlled by a control portion. A control portion may control the flow through a BOG bypass line L1c and a liquefied gas bypass line L4a based on variables such as the internal pressure of a liquefied gas storage tank 10 and a refrigerant state.

In a BOG heat exchanger 21a, a gas flow path is connected to both a BOG line L1 and a liquefied gas line L2, so that the BOG line L1 and the liquefied gas line L2 share the gas flow path with each other. However, a flow of gas through a flow path may be implemented alternatively.

In this case, a line from the point where the BOG line L1 and the liquefied gas line L2 join upstream of the gas flow path to the point where the BOG line L1 and the liquefied gas line L2 are branched off downstream of the gas flow path may be defined as a gas sharing line.

A BOG heat exchanger 21a cools a refrigerant using a BOG discharged from a liquefied gas storage tank 10 and transferred to a demander 40, and may be installed in series with a liquefied gas heat exchanger 22 on a refrigerant line RL.

In other words, a refrigerant line RL may sequentially pass through a BOG heat exchanger 21a and a liquefied gas heat exchanger 22 downstream of a refrigerant compressor 25. Conversely, a refrigerant line RL may sequentially pass through a liquefied gas heat exchanger 22 and a BOG heat exchanger 21a downstream of a supercooler 24 and then be connected to a refrigerant compressor 25.

Similar to a liquefied gas heat exchanger 22, a BOG heat exchanger 21a includes a flow path through which a liquefied gas flows, and a BOG heat exchanger 21a may be provided downstream of a liquefied gas heat exchanger 22 based on the flow of a liquefied gas.

A liquefied gas heat exchanger 22 cools a refrigerant using a liquefied gas discharged from a liquefied gas storage tank 10 and transferred to a demander 40. A liquefied gas heat exchanger 22 may have at least two refrigerant flow paths so that refrigerants heat-exchange with each other while flowing, and may also include a gas flow path through which a liquefied gas flows.

A liquefied gas line L2 may be connected to a gas flow path of a liquefied gas heat exchanger 22 so that a liquefied gas flows, and a liquefied gas in a gas flow path may cool a refrigerant compressed by a refrigerant compressor 25.

A liquefied gas heat exchanger 22 and a BOG heat exchanger 21a are provided in series based on the flow of a refrigerant and a liquefied gas. Therefore, a liquefied gas may transfer the cold heat to a refrigerant in a liquefied gas heat exchanger 22 along a liquefied gas line L2, and then further transfer the cold heat to the refrigerant through a BOG heat exchanger 21a.

Alternatively, a BOG heat exchanger 21a may transfer the cold heat to a refrigerant along a BOG line L1, and since a liquefied gas bypasses a liquefied gas heat exchanger 22, heat exchange between the liquefied gas and the refrigerant may not occur in the liquefied gas heat exchanger 22, but only heat exchange between the refrigerants may occur.

This is because a liquefied gas bypass line L4a is provided to simultaneously bypass both a liquefied gas heat exchanger 22 and a BOG heat exchanger 21a. Of course, when a liquefied gas bypass line L4a may bypass each of a liquefied gas heat exchanger 22 and a BOG heat exchanger 21a, the operation will be possible where a liquefied gas cools a refrigerant in a liquefied gas heat exchanger 22 and at the same time, a BOG cools the refrigerant in a BOG heat exchanger 21a.

Hereinafter, the same description will be provided again based on the flow of a refrigerant. A refrigerant is compressed by a refrigerant compressor 25 and then passes through a refrigerant flow path of a BOG heat exchanger 21a and is transferred to the refrigerant flow path of a liquefied gas heat exchanger 22. The refrigerant is cooled as it receives the cold heat of at least a liquefied gas among a liquefied gas or a BOG, through at least a BOG heat exchanger 21a among a BOG heat exchanger 21a and a liquefied gas heat exchanger 22 according to the control by a control portion.

A refrigerant discharged from a liquefied gas heat exchanger 22 is expanded in a refrigerant expander 23 and then transferred to a supercooler 24. The refrigerant supercools in a supercooler 24 a liquefied gas discharged from a liquefied gas storage tank 10, and then is transferred again to another refrigerant flow path of the liquefied gas heat exchanger 22.

A refrigerant downstream of a supercooler 24 may be cooled by at least a liquefied gas among a liquefied gas and a BOG while it sequentially passes through other refrigerant flow paths of a liquefied gas heat exchanger 22 and other refrigerant flow paths of a BOG gas heat exchanger 21a. Alternatively, the refrigerant downstream of the supercooler 24 may be used to cool a refrigerant compressed in a refrigerant compressor 25.

A refrigerant discharged from another refrigerant flow path of a BOG heat exchanger 21a is introduced into a refrigerant compressor 25 and circulated. In other words, regarding a refrigerant line RL of the present embodiment, a supercooler 24 may be provided on the refrigerant line RL that interconnects a plurality of refrigerant flow paths of a liquefied gas heat exchanger 22, and a refrigerant compressor 25 may be provided on the refrigerant line RL that interconnects a plurality of refrigerant flow paths of a BOG heat exchanger 21a.

Therefore, a refrigerant may receive the cold heat of a BOG or a liquefied gas before and after a supercooler 24 on a refrigerant line RL, thereby ensuring effective supercooling.

In this way, considering that the temperature gradient of a liquefied gas (−160° C. to 40° C.) is wider than that of a BOG (−90° C. to 40° C.), the present embodiment is provided such that a liquefied gas may pass through not only a liquefied gas heat exchanger 22 but also a BOG heat exchanger 21a, and a BOG may pass through only a BOG heat exchanger 21a. In particular, in a BOG heat exchanger 21a, a liquefied gas and a BOG may pass through a same space (a single gas flow path) to perform heat exchange.

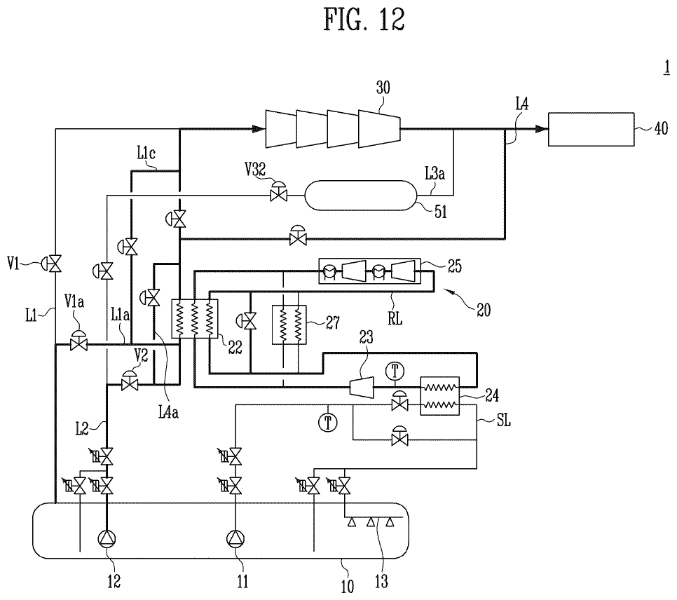

FIG. 12 shows a conceptual diagram of a gas treatment system according to Example 8 of the present invention.

Referring to FIG. 12, compared to the above-described Example 7, a gas treatment system 1 according to Example 8 of the present invention may be provided with a liquefied gas heat exchanger 22, but a liquefied gas heat exchanger 22 may have a gas flow path through which either a liquefied gas or a BOG is alternatively transferred. In addition, a cooling device 20 of the present embodiment may include a refrigerant heat exchanger 27.

Compared to the previous embodiments, the present embodiment may be understood as a form in which the liquefied gas heat exchanger 22 is changed and the BOG heat exchanger 21 is omitted. Alternatively, to explain in another way, the present embodiment may also be interpreted as a form in which the liquefied gas heat exchanger 22 is omitted from the previous embodiments and a BOG heat exchanger 21 is provided.

Alternatively, the present embodiment may be interpreted as an integrated form of the liquefied gas heat exchanger 22 and the BOG heat exchanger 21 described in Example 7. However, for convenience, a gas heat exchanger of the present embodiment will be described below as a liquefied gas heat exchanger 22.

A liquefied gas heat exchanger 22 of the present embodiment may include one refrigerant flow path through which a refrigerant compressed in a refrigerant compressor 25 flows, and another refrigerant flow path through which a refrigerant discharged from a supercooler 24 flows.

In addition, a liquefied gas heat exchanger 22 includes a gas flow path, to which not only a liquefied gas line L2 may be connected, but also a BOG line L1 may be connected. Therefore, a liquefied gas heat exchanger 22 may cool a refrigerant through at least one of a liquefied gas and a BOG.

As mentioned above, a gas flow path of a liquefied gas heat exchanger 22 is provided with a gas sharing line, and a liquefied gas line L2 and a BOG line L1 are joined or branched before and after the gas sharing line.

Depending on the relationship between the amount of BOG discharged from a liquefied gas storage tank 10 and the demand from a demander 40, either a BOG or a liquefied gas may alternatively flow through a gas flow path of a liquefied gas heat exchanger 22.

In this case, the liquefied gas heat exchanger 22 may cool a refrigerant downstream of a refrigerant compressor 25 using a liquefied gas, or may cool a refrigerant downstream of a refrigerant compressor 25 using a BOG.

Of course, as needed, under the premise that the pressure difference is negligible or may be eliminated, the simultaneous introduction of a BOG and a liquefied gas into a gas flow path of a liquefied gas heat exchanger 22 may also be included as an example of the present invention. This may also be applied to the BOG heat exchanger 21 of the previous embodiments.

The present embodiment includes a refrigerant heat exchanger 27 in addition to a liquefied gas heat exchanger 22, and the refrigerant heat exchanger 27 may be provided in parallel with the liquefied gas heat exchanger 22 on a refrigerant line RL.

A refrigerant heat exchanger 27 is configured to mutually heat-exchange between a refrigerant downstream of a refrigerant compressor 25 and a refrigerant downstream of a supercooler 24, and a refrigerant line RL may be branched off downstream of the refrigerant compressor 25, and the branched RLs may be respectively connected to the refrigerant heat exchanger 27 or the liquefied gas heat exchanger 22. Therefore, a part of a refrigerant compressed in a refrigerant compressor 25 may be transferred to a refrigerant heat exchanger 27, and the remainder may be transferred to a liquefied gas heat exchanger 22.

Therefore, a liquefied gas heat exchanger 22 of the present embodiment may serve as a component that cools a refrigerant bypassing a refrigerant heat exchanger 27. In addition, since refrigerant lines RL are joined downstream of each of a liquefied gas heat exchanger 22 and a refrigerant heat exchanger 27 and then transferred to a refrigerant expander 23, the liquefied gas heat exchanger 22 and the refrigerant heat exchanger 27 may be used complementarily for temperature control of a refrigerant.

A refrigerant line RL may have a structure in which it is branched at one point and joins at another point in order to provide a refrigerant heat exchanger 27 and a liquefied gas heat exchanger 22 in parallel. Furthermore, a refrigerant bypass line (reference numeral not shown) may be provided on refrigerant line RL.

A refrigerant bypass line may bypass both a refrigerant heat exchanger 27 and a liquefied gas heat exchanger 22 downstream of a refrigerant compressor 25 to transfer a refrigerant to a refrigerant expander 23. Alternatively, in a converse manner, a refrigerant bypass line may bypass both a refrigerant heat exchanger 27 and a liquefied gas heat exchanger 22 downstream of a supercooler 24 to transfer a refrigerant to a refrigerant compressor 25.

A refrigerant heat exchanger 27 and a liquefied gas heat exchanger 22 may be used in conjunction with each other to control the temperature of a refrigerant, and a refrigerant bypass line may also be used to control the temperature of a refrigerant. A control portion may control the amount of refrigerant flowing from a refrigerant line RL to a refrigerant heat exchanger 27 and a liquefied gas heat exchanger 22 using a valve, or the like, and may also control the amount of refrigerant bypass flow through a refrigerant bypass line.

The case where the refrigerant bypass line shown in the drawing is used may be mainly when there is no need to increase the temperature of refrigerant flowing into a refrigerant compressor 25. Of course, in addition to this, a control portion may control a refrigerant flow through a refrigerant bypass line in various ways depending on the operating status of a refrigerant compressor 25, the pressure and flow rate of a refrigerant circulating along a refrigerant line RL, and the like.

In this way, the present embodiment may alternatively utilize either a liquefied gas or a BOG for refrigerant cooling, and while a single gas heat exchanger is provided, a refrigerant heat exchanger 27 may be disposed in parallel and used.

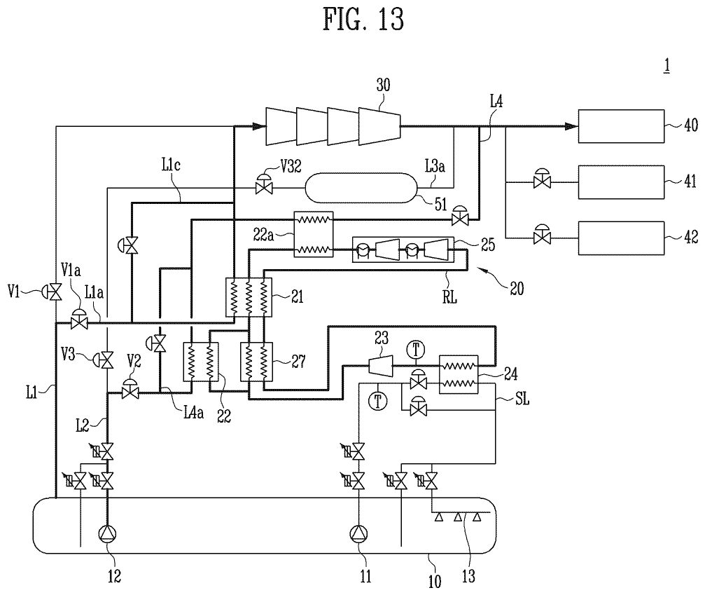

FIG. 13 shows a conceptual diagram of a gas treatment system according to Example 9 of the present invention.

Referring to FIG. 13, in a gas treatment system 1 according to Example 9 of the present invention, a cooling device 20 may include one BOG heat exchanger 21, two liquefied gas heat exchangers 22 and 22a, and a refrigerant heat exchanger 27.

The BOG heat exchanger 21 may allow a refrigerant compressed in a refrigerant compressor 25 and cooled in a liquefied gas heat exchanger 22a, which will be described later, to heat-exchange with a refrigerant discharged from a refrigerant heat exchanger 27. In addition, the BOG heat exchanger 21 may utilize the cold heat of a BOG supplied to a demander 40.

The BOG heat exchanger 21 of the present embodiment is similar to the BOG heat exchanger 21 described in Example 1, but differs in that a liquefied gas heat exchanger 22a and a refrigerant heat exchanger 27 are provided upstream and downstream of the BOG heat exchanger 21, respectively, based on a refrigerant flow downstream of a refrigerant compressor 25.

The liquefied gas heat exchangers 22 and 22a of the present embodiment may be classified into a liquefied gas heat exchanger 22 provided in parallel with a refrigerant heat exchanger 27, and a liquefied gas heat exchanger 22a provided between a refrigerant compressor 25 and a BOG heat exchanger 21.

A liquefied gas heat exchanger 22 disposed in parallel with a refrigerant heat exchanger 27 may be used to supplement the refrigerant temperature control in a refrigerant heat exchanger 27. To this end, a refrigerant line RL may be provided to bypass a refrigerant heat exchanger 27 between a BOG heat exchanger 21 and a refrigerant expander 23, and instead, pass through a liquefied gas heat exchanger 22.

In other words, a refrigerant heat exchanger 27 and a liquefied gas heat exchanger 22 may be used in conjunction with each other to mutually compensate for the temperature control of a refrigerant, and the distribution of the refrigerant may be controlled by a control portion.

In addition, in the present invention, a liquefied gas heat exchanger 22a provided downstream of a refrigerant compressor 25 may cool a refrigerant compressed in the refrigerant compressor 25 using a liquefied gas. At this time, the liquefied gas may be a liquefied gas that has passed through the liquefied gas heat exchanger 22 provided in parallel with a refrigerant heat exchanger 27.

In other words, based on the flow of a liquefied gas, two liquefied gas heat exchangers 22 and 22a may be provided in series. Of course, at least one of the liquefied gas heat exchangers 22 and 22a may be provided to allow bypass of a liquefied gas.

On the other hand, based on the flow of a refrigerant, two liquefied gas heat exchangers 22 and 22a may be provided in series with a BOG heat exchanger 21 therebetween. Of course, the BOG heat exchanger 21 also has a structured that allows bypass of a BOG.

As mentioned above, the present embodiment takes into consideration the fact that the temperature gradient of a liquefied gas (−160° C. to 40° C.) is wider than the temperature gradient of a BOG (−90° C. to 40° C.). In other words, the present embodiment was provided so that a liquefied gas passes through both liquefied gas heat exchangers 22 and 22a, and a BOG passes through only one BOG heat exchanger 21.

In addition, in the present embodiment, a liquefied gas heat exchanger 22 may be configured in parallel with a refrigerant heat exchanger 27 to cool a part of a refrigerant, and the remaining cold heat may be used completely in a liquefied gas heat exchanger 22a.

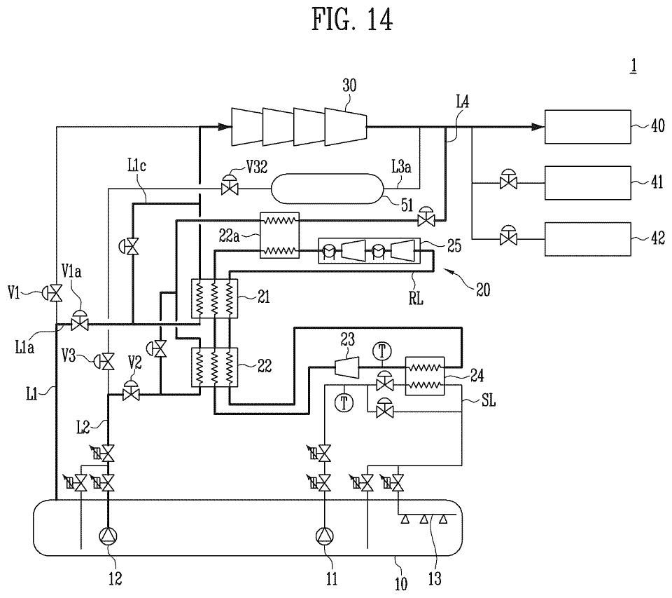

FIG. 14 shows a conceptual diagram of a gas treatment system according to Example 10 of the present invention.

Referring to FIG. 14, a gas treatment system 1 according to Example 10 of the present invention is the same as Example 9 in that two liquefied gas heat exchangers 22 and 22a and one BOG heat exchanger 21 are provided, but a separate refrigerant heat exchanger 27 may be omitted.

In the present embodiment, instead of providing a separate refrigerant heat exchanger 27 that only implements heat exchange between refrigerants without a flow of liquefied gas or a BOG, heat exchange between refrigerants may be sufficiently achieved in a liquefied gas heat exchanger 22 or a BOG heat exchanger 21.

For example, in the present embodiment, a BOG heat exchanger 21 may be provided with a plurality of refrigerant flow paths so that refrigerants undergo heat exchange with each other in the BOG heat exchanger 21 before and after a refrigerant compressor 25 to be cooled by a BOG.

In addition, in the present embodiment, at least one liquefied gas heat exchanger 22 of two liquefied gas heat exchangers 22 and 22a is provided with a plurality of refrigerant flow paths. Therefore, refrigerants may undergo heat exchange with each other in the liquefied gas heat exchanger 22 before and after a supercooler 24 to be cooled by a liquefied gas.

In other words, the present embodiment may be understood as an integrated form of the liquefied gas heat exchanger 22 and the refrigerant heat exchanger 27 that were provided in parallel in the previous embodiments.

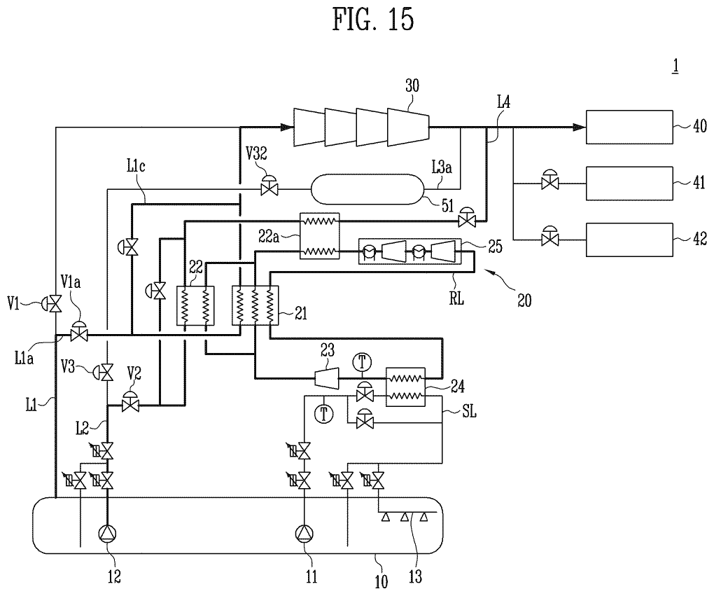

FIG. 15 shows a conceptual diagram of a gas treatment system according to Example 11 of the present invention.

Referring to FIG. 15, a gas treatment system 1 according to Example 11 of the present invention may be provided with one BOG heat exchanger 21 and two liquefied gas heat exchangers 22 and 22a.

The one BOG heat exchanger 21 is similar to that described in Example 10, but in the present embodiment, a separate heat exchange component may not be added between a BOG heat exchanger 21 and a refrigerant expander 23 based on a refrigerant line RL.

In addition, in the present embodiment, at least one of two liquefied gas heat exchangers 22 and 22a may be provided in parallel with a BOG heat exchanger 21 based on a refrigerant flow. In other words, a refrigerant that has passed through a refrigerant compressor 25 and one liquefied gas heat exchanger 22a may be branched off through a refrigerant line RL and transferred to another liquefied gas heat exchanger 22 or a BOG heat exchanger 21.

A refrigerant that has passed through another liquefied gas heat exchanger 22 and a BOG heat exchanger 21 may be joined upstream of a refrigerant expander 23 and transferred to a supercooler 24. Therefore, the other liquefied gas heat exchanger 22 and the BOG heat exchanger 21 may be utilized and controlled in conjunction with each other to control the temperature of a refrigerant.

Two liquefied gas heat exchangers 22 and 22a may be disposed in series based on a liquefied gas line L2, and a liquefied gas heat exchanger 22 provided upstream may be disposed in parallel with a BOG heat exchanger 21 based on a refrigerant line RL.

In addition, one liquefied gas heat exchanger 22a and the other liquefied gas heat exchanger 22 may be provided in series based on a refrigerant flow downstream of a refrigerant compressor 25 on a refrigerant line RL, and one liquefied gas heat exchanger 22a may be provided in series with a BOG heat exchanger 21.

In the present embodiment, liquefied gas heat exchangers 22 and 22a may have a form provided with two flow paths to handle mutual heat exchange between a refrigerant and a liquefied gas, and they may have a form in which a BOG heat exchanger 21 handles mutual heat exchange between refrigerants and cooling through a BOG. In other words, a BOG heat exchanger 21 may have a plurality of refrigerant flow paths and at least one gas flow path, while liquefied gas heat exchangers 22 and 22a may have one refrigerant flow path and at least one gas flow path.

In the present embodiment, a liquefied gas heat exchanger 22 provided upstream based on a flow of liquefied gas may be omitted. In this case, one liquefied gas heat exchanger 22a and one BOG heat exchanger 21 may be provided, and a refrigerant is cooled sequentially in the liquefied gas heat exchanger 22a and the BOG heat exchanger 21 after compression, and then introduced into a supercooler 24 through a cooling expander.

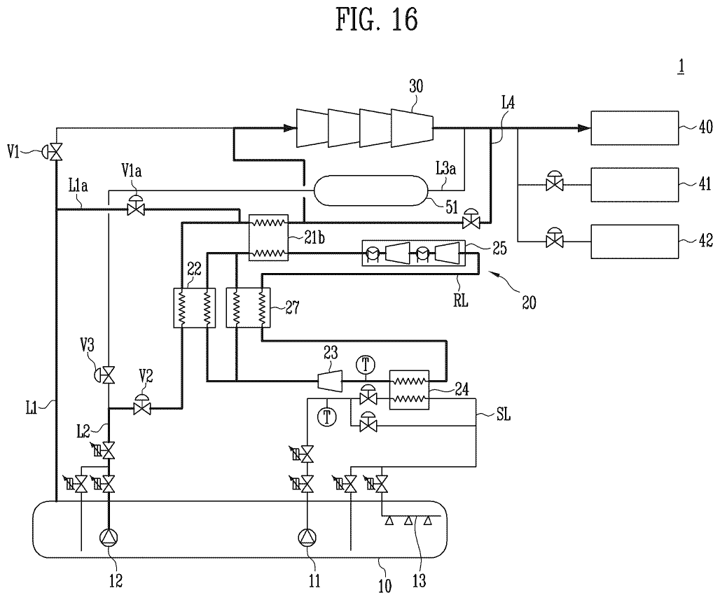

FIG. 16 shows a conceptual diagram of a gas treatment system according to Example 12 of the present invention.

Referring to FIG. 16, similar to Example 9 described with reference to FIG. 13, in a gas treatment system 1 according to Example 12 of the present invention, a refrigerant heat exchanger 27 and a liquefied gas heat exchanger 22 may be disposed in parallel.

Furthermore, the present embodiment further includes a modified BOG heat exchanger 21b. The BOG heat exchanger 21b of the present embodiment may be provided between a refrigerant compressor 25 and a refrigerant heat exchanger 27 or between a refrigerant compressor 25 and a liquefied gas heat exchanger 22 on a refrigerant line RL. The BOG heat exchanger 21b may cool a refrigerant compressed in a refrigerant compressor 25 with a BOG flowing along a BOG line L1.

In addition, a BOG heat exchanger 21b of the present embodiment may allow a BOG or a liquefied gas to flow through one gas flow path. In other words, similar to the BOG heat exchanger 21a described in Example 7, a BOG heat exchanger 21b of the present embodiment may be provided with a gas flow path shared by a liquefied gas line L2 and a BOG line L1.

Specifically, a BOG heat exchanger 21b may be provided with a gas flow path to which a BOG line L1 upstream of a main compressor 30 is connected. At this time, a liquefied gas line L2 may also be connected to the gas flow path of the BOG heat exchanger 21b.

However, a gas flow path of a BOG heat exchanger 21b may be connected to a downstream part of a liquefied gas heat exchanger 22 on a liquefied gas line L2. In other words, a liquefied gas heat exchanger 22 and a BOG heat exchanger 21b may be sequentially disposed in series based on a flow of liquefied gas.

In this case, the BOG heat exchanger 21b may cool a refrigerant compressed in a refrigerant compressor 25 using a BOG introduced to a main compressor 30, or may cool a refrigerant using the remaining cold heat of a liquefied gas that has been heat-exchanged with the refrigerant in a liquefied gas heat exchanger 22.

Of course, a liquefied gas line L2 may be provided to bypass a liquefied gas heat exchanger 22, so that a BOG heat exchanger 21b may cool a refrigerant using a liquefied gas discharged from a liquefied gas storage tank 10 and flowing through a liquefied gas line L2.

Through a gas flow path of a BOG heat exchanger 21b, either a BOG or a liquefied gas may flow alternatively. To this end, a BOG line L1 and a liquefied gas line L2 are joined or branched off upstream or downstream of a gas flow path provided in a BOG heat exchanger 21b. In addition, as described above, a gas flow path may be referred to as a gas sharing line.

In the preset embodiment, a refrigerant heat exchanger 27 and a liquefied gas heat exchanger 22 may be provided in parallel on a refrigerant line RL, so that the refrigerant heat exchanger 27 and the liquefied gas heat exchanger 22 may be provided in series on the refrigerant line RL based on a BOG heat exchanger 21b. In this case, a refrigerant may be compressed by and discharged from a refrigerant compressor 25, then cooled by a BOG or a liquefied gas in the BOG heat exchanger 21b and transferred to a supercooler 24 via the refrigerant heat exchanger 27 or the liquefied gas heat exchanger 22.

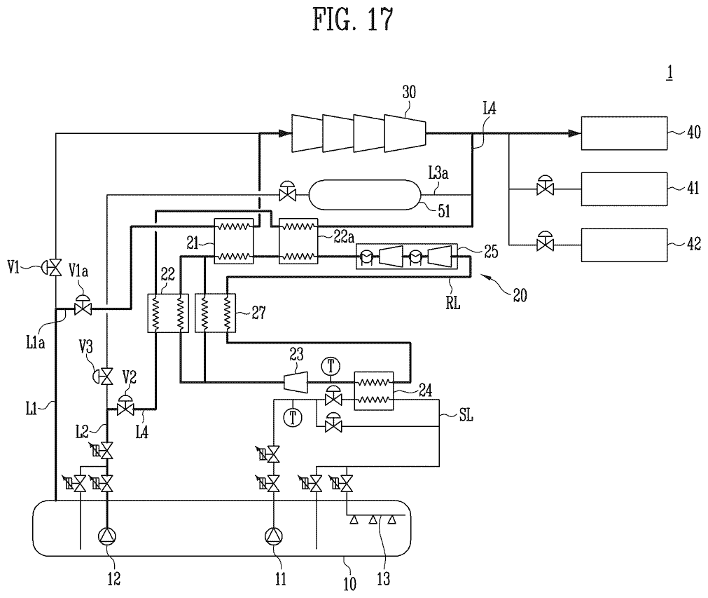

FIG. 17 shows a conceptual diagram of a gas treatment system according to Example 13 of the present invention.

Referring to FIG. 17, a gas treatment system 1 according to Example 13 of the present invention may be configured by dividing the BOG heat exchanger 21 described in Example 12 into one BOG heat exchanger 21 and one liquefied gas heat exchanger 22a.

In this case, a liquefied gas heat exchanger 22a and a BOG heat exchanger 21 are sequentially provided based on a refrigerant line RL, and then a refrigerant heat exchanger 27 and a liquefied gas heat exchanger 22 may be disposed in parallel.

Therefore, a refrigerant may be sequentially cooled in a liquefied gas heat exchanger 22a and a BOG heat exchanger 21, and then transferred to a refrigerant expander 23 through heat exchange between refrigerants in a refrigerant heat exchanger 27. Alternatively, a refrigerant is sequentially cooled through a liquefied gas heat exchanger 22a and a BOG heat exchanger 21, and then cooled by a liquefied gas in another liquefied gas heat exchanger 22 and transferred to a refrigerant expander 23.

In the above embodiments, when a BOG heat exchanger 21b provided downstream of a liquefied gas heat exchanger 22 based on a flow of liquefied gas receives a BOG, a liquefied gas transfers cold heat to a refrigerant through one liquefied gas heat exchanger 22.

On the other hand, in the present embodiment, two liquefied gas heat exchangers 22 and 22a are provided based on a flow of liquefied gas, and a BOG heat exchanger 21 is provided independently from the liquefied gas heat exchanger 22a. Therefore, in the present embodiment, a liquefied gas may undergo two-stage heat exchange with a refrigerant regardless of the operation of transferring cold heat to the refrigerant using a BOG. Through this, the present embodiment may sufficiently recover the cold heat of a liquefied gas using a refrigerant.

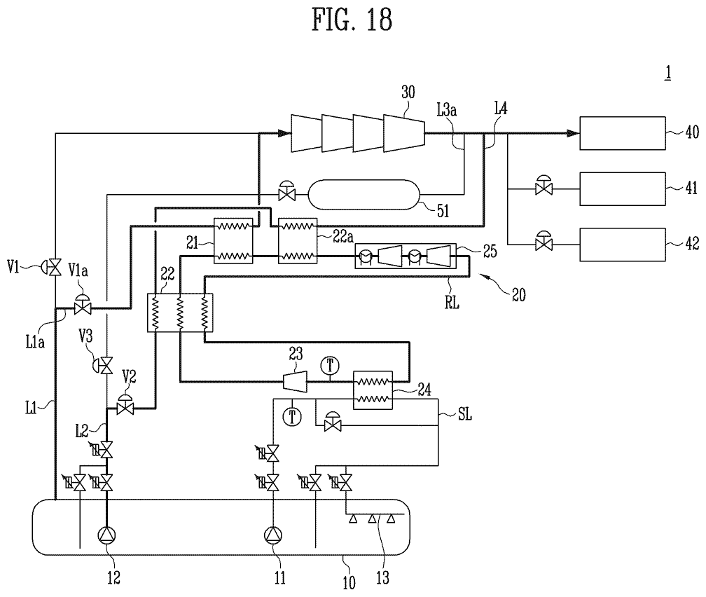

FIG. 18 shows a conceptual diagram of a gas treatment system according to Example 14 of the present invention.

Referring to FIG. 18, a gas treatment system 1 according to Example 14 of the present invention may integrate a liquefied gas heat exchanger 22 and a refrigerant heat exchanger 27 provided in parallel in Example 13.

The present embodiment may be provided with two liquefied gas heat exchangers 22 and 22a and one BOG heat exchanger 21, and the liquefied gas heat exchanger 22 provided upstream based on a flow of liquefied gas may include a plurality of refrigerant flow paths and at least one gas flow path.

Therefore, based on a refrigerant line RL, a refrigerant may be cooled by the cold heat of a liquefied gas and a BOG while sequentially flowing through one liquefied gas heat exchangers 22a, a BOG heat exchanger 21, and a liquefied gas heat exchanger 22.

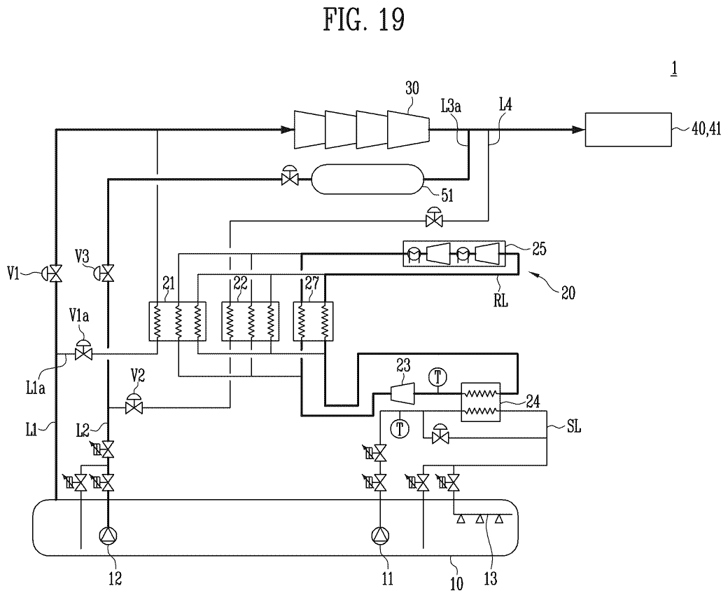

FIGS. 19 to 21 show conceptual diagrams of a gas treatment system according to Example 15 of the present invention.

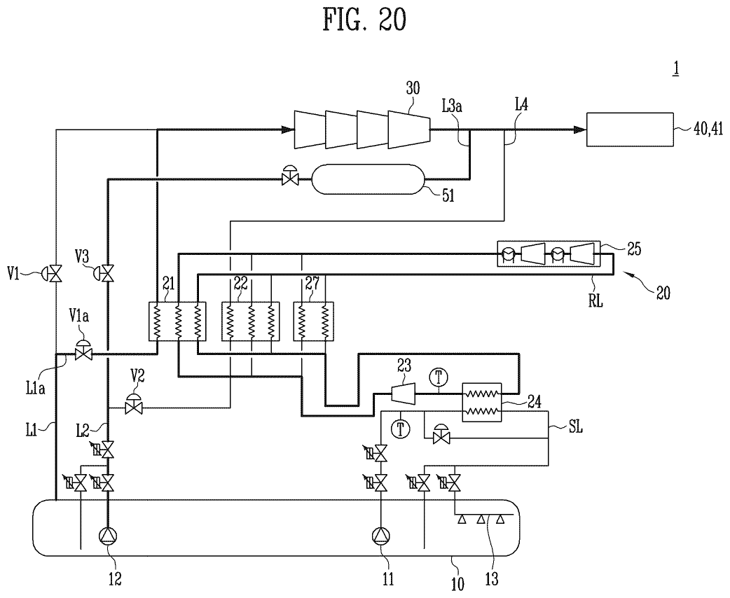

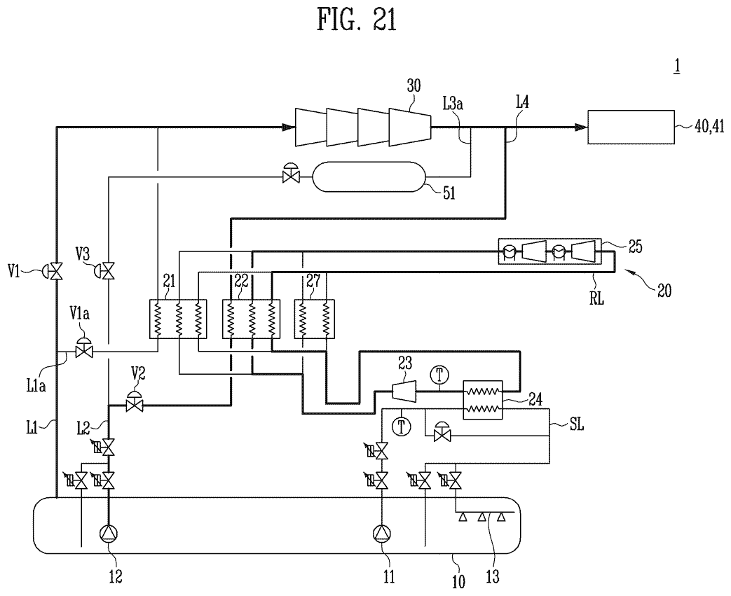

For reference, FIG. 19 illustrates a case where the cold heat of a BOG gas and a liquefied gas is not transferred to a refrigerant, FIG. 20 illustrates a case where only the cold heat of a BOG is transferred to a refrigerant, and FIG. 21 illustrates a case where only the cold heat of a liquefied gas is transferred to a refrigerant.

Referring to FIGS. 19 to 21, a gas treatment system 1 according to Example 15 of the present invention may be provided with each of a refrigerant heat exchanger 27, an BOG heat exchanger 21, and a liquefied gas heat exchanger 22, all of which may be disposed in parallel based on a refrigerant line RL.

In this case, the refrigerant may be circulated along various closed circulation loops. For example, as shown in FIG. 19, the refrigerant of the present embodiment may be circulated along a refrigerant compressor 25, a refrigerant heat exchanger 27, a refrigerant expander 23, and a supercooler 24, and may not receive the cold heat of a liquefied gas or a BOG supplied to a demander 40.

Alternatively, as shown in FIG. 20, a refrigerant may be circulated along a refrigerant compressor 25, a BOG heat exchanger 21, a refrigerant expander 23, and a supercooler 24. In this case, the BOG heat exchanger 21 may include a gas flow path and a refrigerant flow path, and may include a plurality of refrigerant flow paths. Therefore, the BOG heat exchanger 21 may transfer the cold heat of a BOG to the refrigerant while mutually heat-exchanging between the refrigerant compressed by the refrigerant compressor 25 and the refrigerant before being compressed by the refrigerant compressor 25.

Alternatively, as shown in FIG. 21, a refrigerant may be circulated along the refrigerant compressor 25, a liquefied gas heat exchanger 22, a refrigerant expander 23, and a supercooler 24. In this case, the liquefied gas heat exchanger 22 may include at least one gas flow path and a plurality of refrigerant flow paths, thereby implementing heat exchange between refrigerants and cooling of the refrigerants through the liquefied gas before and after the refrigerant compressor 25.

In the present embodiment, a refrigerant may be controlled not to utilize the cold heat of a liquefied gas and a BOG as needed, or a refrigerant may be controlled to utilize the cold heat of either a liquefied gas or a BOG.

In addition, in the present embodiment, a refrigerant line RL is branched into a refrigerant heat exchanger 27, a BOG heat exchanger 21, and a liquefied gas heat exchanger 22 downstream of a refrigerant compressor 25, and the flow rate of the branched refrigerant may be controlled by a control portion. Therefore, a refrigerant may be cooled by the cold heat of at least one of a liquefied gas and a BOG.

In other words, the present embodiment can implement control that combines non-utilization of cooling heat, utilization of cooling heat of BOG, utilization of cooling heat of liquefied gas, and the like, so that cooling control for a refrigerant may be performed in various ways.

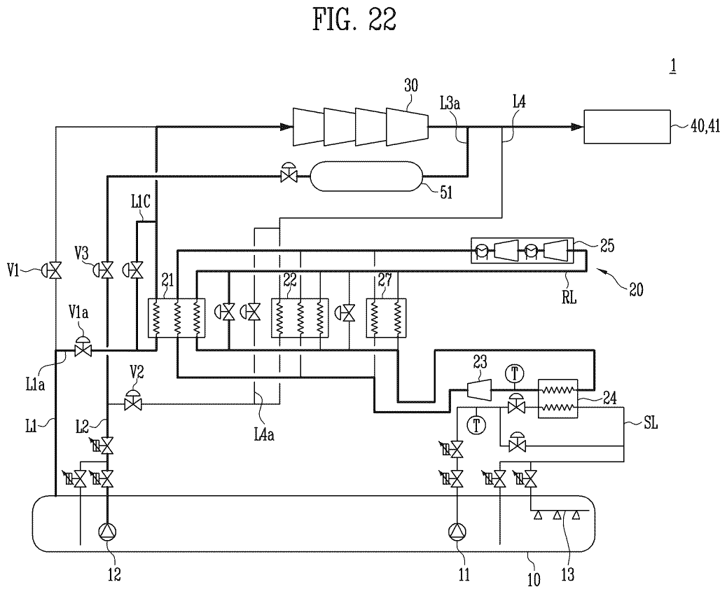

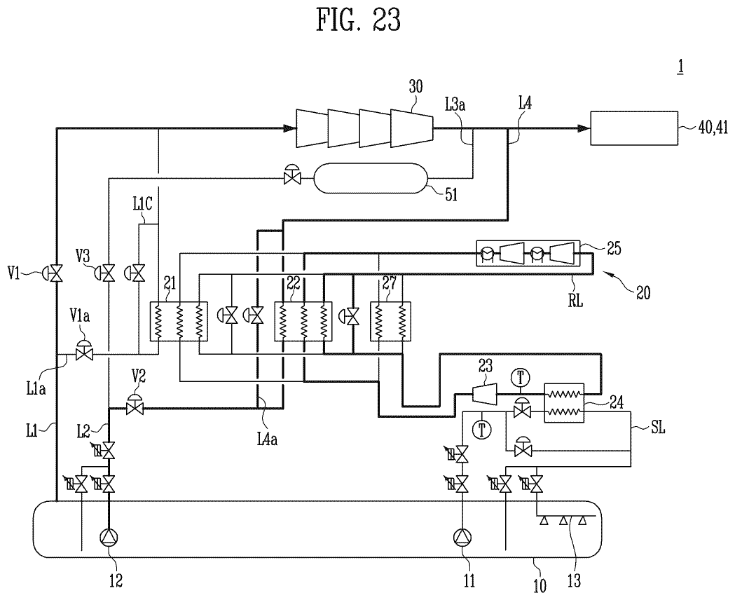

FIGS. 22 and 23 show conceptual diagrams of a gas treatment system according to Example 16 of the present invention.

FIG. 22 illustrates a case where a refrigerant is cooled by the cold heat of a BOG, and FIG. 23 illustrates a case where a refrigerant is cooled by a liquefied gas.

Of course, although not shown, like Example 15, it is possible in the present embodiment that heat exchange occurs only between refrigerants without a refrigerant recovering the cold heat of a liquefied gas and a BOG.

Referring to FIGS. 22 and 23, similar to Example 15, a gas treatment system 1 according to Example 16 of the present invention may be provided with a refrigerant heat exchanger 27, a BOG heat exchanger 21, and a liquefied gas heat exchanger 22, and the refrigerant heat exchanger 27, the BOG heat exchanger 21, and the liquefied gas heat exchanger 22 may be disposed in parallel based on a refrigerant line RL.

However, compared to Example 15, the present embodiment may further include a refrigerant bypass line (reference numeral not shown). The refrigerant bypass line may be provided to bypass a refrigerant heat exchanger 27, a BOG heat exchanger 21, and a liquefied gas heat exchanger 22 on a refrigerant line RL.

A refrigerant line RL is branched downstream of a refrigerant compressor 25 to a refrigerant heat exchanger 27, a BOG heat exchanger 21, and a liquefied gas heat exchanger 22, and the present embodiment may further implement a flow in which a refrigerant is transferred from a supercooler 24 to the refrigerant compressor 25 without heat exchange by bypassing the refrigerant heat exchanger 27, and the like.

In this case, in the present embodiment, the inlet temperature of the refrigerant compressor 25 may be controlled by controlling a refrigerant flow in a refrigerant bypass line through a control portion. To this end, a refrigerant bypass valve may be provided on the refrigerant bypass line.

Specifically, in the case of FIG. 22, the refrigerant flows along the BOG heat exchanger 21 and the refrigerant bypass line after supercooling the liquefied gas in the supercooler 24. Therefore, a part of the refrigerant is cooled by the BOG supplied to a demander 40, and the remainder is transferred to the refrigerant compressor 25 without cooling by the BOG. Since the refrigerant flowing along the refrigerant bypass line is not cooled by the BOG, the inlet temperature of the refrigerant compressor 25 may rise when the refrigerant flow rate in the refrigerant bypass line increases.

On the other hand, when the flow rate of the refrigerant flowing along the refrigerant bypass line is reduced or eliminated, the inlet temperature of the refrigerant compressor 25 may be lowered. In this way, the present embodiment may increase the supercooling efficiency by cooling the refrigerant with the cold heat of the BOG, while appropriately controlling the inlet temperature of the refrigerant compressor 25.

On the other hand, in the case of FIG. 23, the refrigerant may flow along the liquefied gas heat exchanger 22 and the refrigerant bypass line, after supercooling the liquefied gas in the supercooler 24. In other words, a part of the refrigerant may be introduced into a refrigerant flow path of the liquefied gas heat exchanger 22 and be cooled by the liquefied gas, and the remainder may bypass the liquefied gas heat exchanger 22 along the refrigerant bypass line and not recover the cold heat of the liquefied gas.

As described above with reference to FIG. 22, in the case of FIG. 23, the inlet temperature of the refrigerant compressor 25 may be appropriately controlled by controlling the bypass flow rate of the refrigerant bypass line. This operation may be implemented by the control portion.

In addition, although not shown in the drawing, it is possible that a part of the refrigerant discharged from the supercooler 24 is introduced into the refrigerant heat exchanger 27 and the remainder bypasses the refrigerant heat exchanger 27.

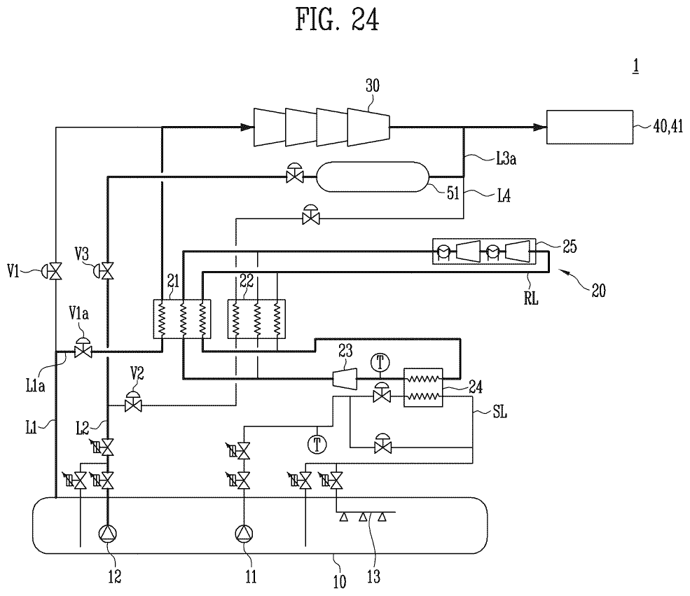

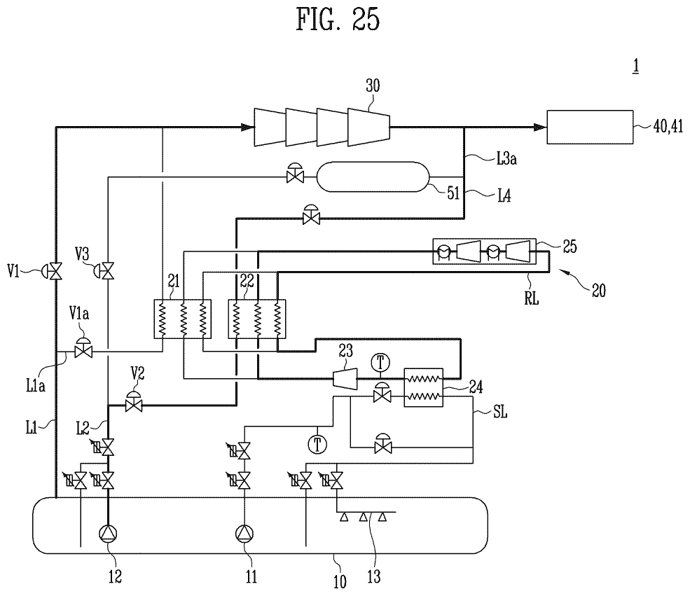

FIGS. 24 and 25 show conceptual diagrams of a gas treatment system according to Example 17 of the present invention.

For reference, FIG. 24 shows a state in which a refrigerant is cooled using a BOG, and FIG. 25 shows a state in which a refrigerant is cooled using a liquefied gas. Of course, it is also possible in the present embodiment to cool a refrigerant using both a BOG and a liquefied gas.

Referring to FIGS. 24 and 25, a gas treatment system 1 according to Example 17 of the present invention may be provided with a liquefied gas heat exchanger 22 and a BOG heat exchanger 21, and a separate refrigerant heat exchanger 27 may not be provided.

Similar to those described in Example 1, the present embodiment may be provided with a liquefied gas heat exchanger 22 and a BOG heat exchanger 21. However, unlike Example 1 where a liquefied gas heat exchanger 22 and a BOG heat exchanger 21 are disposed in series based on a refrigerant line RL, in the present embodiment, a liquefied gas heat exchanger 22 and a BOG heat exchanger 21 may be disposed in parallel based on a refrigerant line RL.

Therefore, in the case of FIG. 24, a refrigerant may flow along a refrigerant line RL and pass through only a BOG heat exchanger 21 among a BOG heat exchanger 21 and a liquefied gas heat exchanger 22 downstream of a refrigerant compressor 25, and then be transferred to a refrigerant expander 23.

On the other hand, in the case of FIG. 25, a refrigerant may flow along a refrigerant line RL and pass through only a liquefied gas heat exchanger 22 among a BOG heat exchanger 21 and a liquefied gas heat exchanger 22 downstream of a refrigerant compressor 25, and then be transferred to a refrigerant expander 23.

Of course, although not shown in the drawing, in the present embodiment, a refrigerant may be distributed to a BOG heat exchanger 21 and a liquefied gas heat exchanger 22 downstream of a refrigerant compressor 25. In this case, the BOG heat exchanger 21 and the liquefied gas heat exchanger 22 may be operated in conjunction with each other to control the temperature of the refrigerant. At this time, a control portion may control the distribution of the refrigerant based on the flow rate of the BOG and the liquefied gas supplied to a demander 40, the temperature of the BOG and the liquefied gas, and the like.

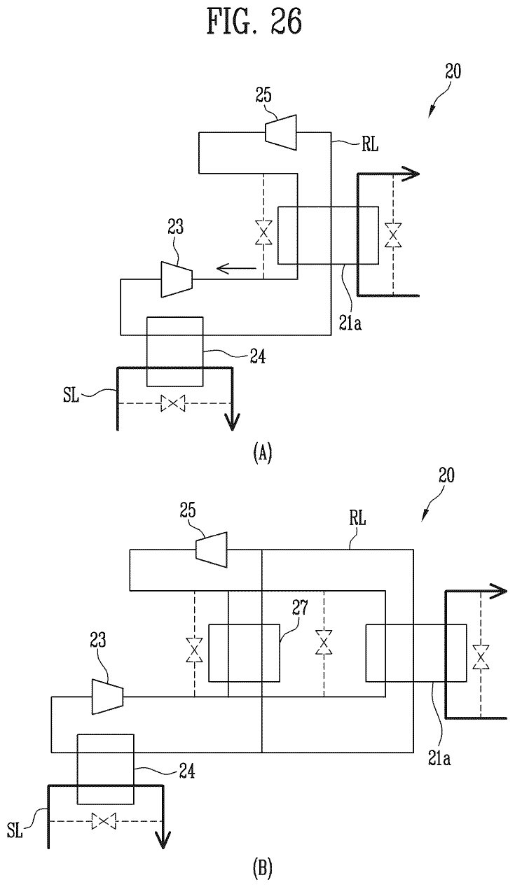

FIGS. 26 to 30 show conceptual diagrams of gas treatment systems according to examples of the present invention.

A gas treatment system 1 shown in FIGS. 26 to 30 is a simplified illustration of only the cooling device 20 part in the previously described embodiments. In addition, in FIGS. 26 to 30, a bypass line (reference numeral not shown) and a bypass valve (reference numeral not shown) are illustrated in dotted lines to bypass a gas heat exchanger 21, 21a, and 22 or a supercooler 24, and a refrigerant heat exchanger 27, but, of course, the bypass line and the like may be added or omitted as needed.

Referring to FIG. 26, the present invention includes an embodiment in which a gas heat exchanger has one flow path that allows for a flow of a liquefied gas or a BOG.

Specifically, FIG. 26A relates to the cooling device 20 of FIG. 11. In other words, according to FIG. 26A, a refrigerant acquires cold heat through either a BOG or a liquefied gas and uses it to supercool the liquefied gas in a supercooler 24, and at this time, a gas heat exchanger 21a that cools the refrigerant is provided so that either the liquefied gas or the BOG may alternatively flow on one flow path.

In addition, FIG. 26B relates to the cooling device 20 of FIG. 12, and it has a form in which a refrigerant heat exchanger 27 is added separately in addition to a gas heat exchanger.

Of course, FIG. 26B may also be interpreted as showing a part of the configuration of FIG. 16.

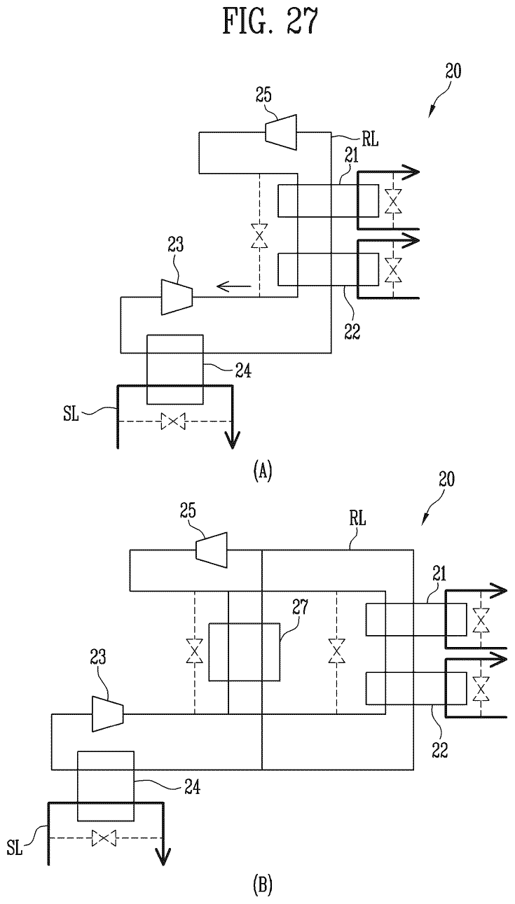

Referring to FIG. 27, the present invention includes an embodiment in which a BOG heat exchanger 21 and a liquefied gas heat exchanger 22 are disposed in series based on a refrigerant line RL.

Specifically, FIG. 27A may relate to the cooling device 20 of FIG. 1. Of course, FIG. 27A may also be interpreted as showing a part of the configuration of the cooling device 20 included in FIG. 14, FIG. 18, and the like.

In addition, in the case of FIG. 27B, a refrigerant heat exchanger 27 may be added in comparison with FIG. 27A. In this case, it may be related to the cooling device 20 shown in FIG. 17 and the like.

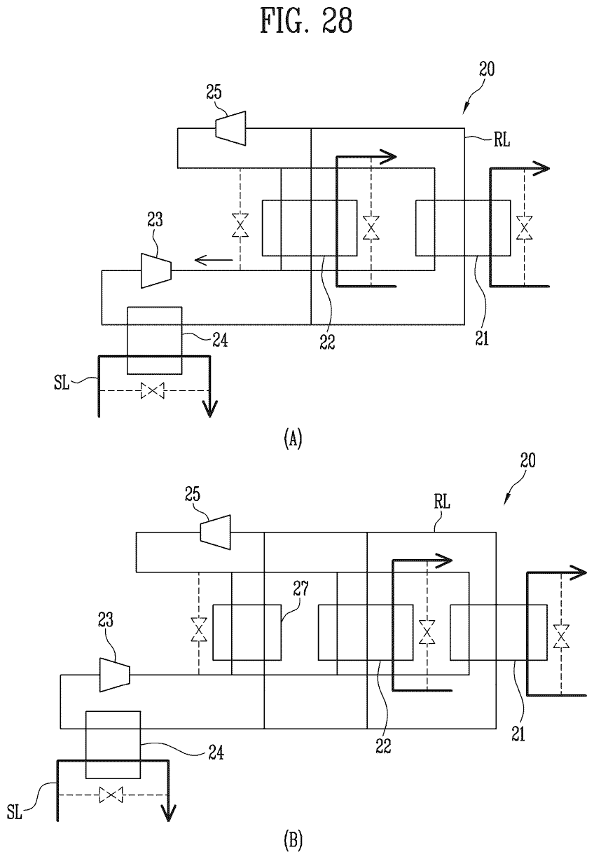

Referring to FIG. 28, the present invention includes an embodiment in which a BOG heat exchanger 21 and a liquefied gas heat exchanger 22 are disposed in parallel based on a refrigerant line RL.

Specifically, FIG. 28 may relate to the cooling device 20 described in FIG. 24, FIG. 25, and the like.

In the case of FIG. 28, a separate refrigerant heat exchanger 27 may be added in comparison with FIG. 28A, and in this case, it may relate to the cooling device 20 shown in FIGS. 19 to 23, and the like.

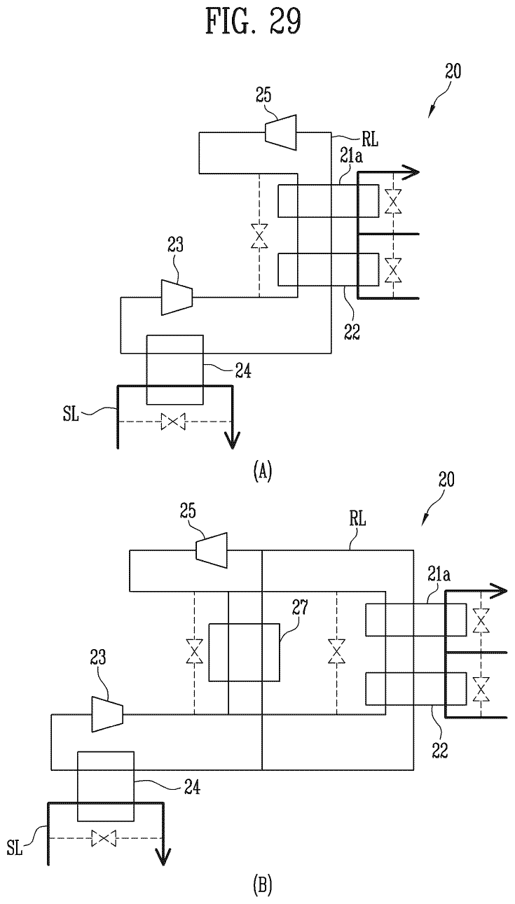

Referring to FIG. 29, the present invention includes an embodiment in which two gas heat exchangers 22 and 21a are disposed in series based on a refrigerant line RL.

Specifically, in the case of FIG. 29A, as two gas heat exchangers 22 and 21a, a liquefied gas heat exchanger 22 and a BOG heat exchanger 21a may be sequentially provided. At this time, at least one gas heat exchanger 22 and 21a among the liquefied gas heat exchanger 22 and the BOG heat exchanger 21a may have a structure in which either a BOG or a liquefied gas alternatively flows on one flow path.

FIG. 29A may correspond to a cooling device 20 of FIG. 11. For reference, FIG. 26, which was described as being related to FIG. 11, is different from FIG. 29A in that a liquefied gas heat exchanger 22 shown in FIG. 11 is omitted.

In the case of FIG. 29B, a refrigerant heat exchanger 27 is separately added compared to FIG. 29A. FIG. 29B may be understood as being related to the cooling device 20 of FIG. 12, and furthermore, it may be understood as corresponding to the cooling device 20 of FIG. 16.

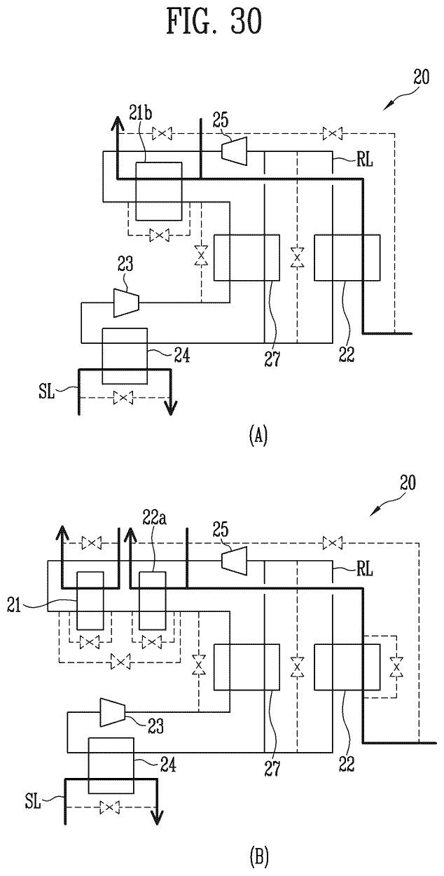

Referring to FIG. 30, the present invention includes a case where a plurality of gas heat exchangers 22, 21b, and 21 are provided, a refrigerant heat exchanger 27 is provided but one of the plurality of gas heat exchangers 22, 21b, and 21 is disposed in parallel with the refrigerant heat exchanger 27 on a refrigerant line RL, and at least one other is disposed in series with the refrigerant heat exchanger 27.

Specifically, in the case of FIG. 30A, a liquefied gas heat exchanger 22 may be provided in parallel with a refrigerant heat exchanger 27. In addition, FIG. 30A may be provided with a BOG heat exchanger 21b, and the BOG heat exchanger 21b may have a structure in which either a liquefied gas or a BOG is alternatively supplied on one flow path. This BOG heat exchanger 21b may be provided in series with a refrigerant heat exchanger 27.

In addition, a liquefied gas heat exchanger 22 and a BOG heat exchanger 21b are disposed in series based on a refrigerant line RL. A liquefied gas heat exchanger 22 may be disposed between a supercooler 24 and a refrigerant compressor 25, and a BOG heat exchanger 21b may be disposed between a refrigerant compressor 25 and a refrigerant heat exchanger 27.

In the case of FIG. 30B, a BOG heat exchanger 21b is divided into a BOG heat exchanger 21 and a liquefied gas heat exchanger 22a in comparison with FIG. 30A, and in this case, there may not be a line in which a liquefied gas and a BOG are shared.

In addition, the present invention may further include, as another embodiment, a structure capable of supercooling a liquefied gas through various combinations of a gas heat exchanger and a refrigerant heat exchanger 27.

The present invention is not limited to the embodiments described above, and it is obvious that a combination of the embodiments described above or a combination of at least one of the embodiments described above and a known technology may be included as other embodiments.

Although the present invention has been described in detail through specific embodiments, this is for specifically explaining the present invention, and the present invention is not limited thereto, and it will be obvious that modifications or improvements can be made by those skilled in the art within the technical ideas of the present invention.

All simple modifications or changes of the present invention fall within the scope of the present invention, and the specific protection scope of the present invention will be made clear by the appended claims.

[Reference Numerals]

1: Gas treatment system
10: Liquefied gas storage tank
11: First pump
12: Second pump
13: Injection device
14: Ejector
15: BOG condenser
20: Cooling device
21, 21a, and 21b: BOG gas heat exchanger
22, 22a: Liquefied gas heat exchanger
23: Refrigerant expander
231: Distributor
24: Supercooler
25: Refrigerant compressor
26: Refrigerant cooler
27: Refrigerant heat exchanger
28: Integrated heat exchanger
30: Main compressor
40: Demander
41: Power generation engine
42: GCU
50: Mixer
51: Liquefied gas heater
L1: BOG line
L1a: BOG branch line
L1c: BOG bypass line
L2: Liquefied gas line
L2a: Liquefied gas mixing line
L3: Liquefied gas bypass line
L3a: Liquefied gas heating line
L4: Liquefied gas transfer line
L4a: Liquefied gas bypass line
SL: Supercooling line
RL: Refrigerant line
RL1: First refrigerant line
RL2: Second refrigerant line
V1: BOG valve
V1a: BOG branch valve
V2: Liquefied gas branch valve
V21: First liquefied gas mixing valve
V22: Second liquefied gas mixing valve
V3: Liquefied gas supply valve
V31: Liquefied gas bypass valve
V32: Liquefied gas heating valve
V4: Liquefied gas transfer valve

1. A gas treatment system comprising:
a liquefied gas storage tank;
a cooling device supercooling and returning a liquefied gas of the liquefied gas storage tank; and
a main compressor pressurizing a boil off gas of the liquefied gas storage tank and supply it to a demander,
wherein the cooling device includes:
a supercooler for supercooling a liquefied gas with a refrigerant; and
a gas heat exchanger cooling a refrigerant using at least one of a boil off gas discharged from the liquefied gas storage tank and transferred to the demander or a liquefied gas discharged from the liquefied gas storage tank and transferred to the demander,
wherein the gas heat exchanger has a refrigerant flow path through which a refrigerant flows and a gas flow path through which at least one of a liquefied gas or a boil off gas flows.

2. The gas treatment system according to claim 1, further comprising:
a boil off gas line transferring a boil off gas from the liquefied gas storage tank to the demander; and
a liquefied gas line transferring a liquefied gas from the liquefied gas storage tank to the demander,
wherein the boil off gas line and the liquefied gas line are provided to share the gas flow path of the gas heat exchanger.

3. The gas treatment system according to claim 2, further comprising:
a boil off gas bypass line branched off from the boil off gas line and bypassing the gas heat exchanger;
a liquefied gas bypass line branched off from the liquefied gas line and bypassing the gas heat exchanger; and
a control portion controlling a flow of the boil off gas bypass line and the liquefied gas bypass line.

4. The gas treatment system according to claim 2, wherein the cooling device further includes:
a refrigerant line through which a refrigerant circulates,
wherein the gas heat exchanger has a plurality of refrigerant flow paths connected to the refrigerant line, and the supercooler is provided on the refrigerant line interconnecting the plurality of refrigerant flow paths of the gas heat exchanger.

5. The gas treatment system according to claim 4, wherein the cooling device further includes:
a refrigerant compressor compressing a refrigerant and transferring it to one of the refrigerant flow paths of the gas heat exchanger; and
a refrigerant expander expanding a refrigerant discharged from one of the refrigerant flow paths of the gas heat exchanger and transferring it to the supercooler.

6. The gas treatment system according to claim 4, wherein the gas heat exchanger includes:
a boil off gas heat exchanger cooling a refrigerant with a boil off gas discharged from the liquefied gas storage tank and transferred to the demander; and
a liquefied gas heat exchanger cooling a refrigerant with a liquefied gas discharged from the liquefied gas storage tank and transferred to the demander,
wherein the boil off heat exchanger and the liquefied gas heat exchanger are provided in series on the refrigerant line.

7. The gas treatment system according to claim 6, wherein the boil off gas heat exchanger has the gas flow path shared by the boil off gas line and the liquefied gas line and is provided downstream of the liquefied gas heat exchanger based on a flow of liquefied gas.

8. The gas treatment system according to claim 5, wherein the cooling device further includes a refrigerant heat exchanger mutually heat-exchanging a refrigerant downstream of the refrigerant compressor and a refrigerant downstream of the supercooler,
wherein the refrigerant heat exchanger is provided in parallel with the gas heat exchanger.

9. The gas treatment system according to claim 5, wherein the gas heat exchanger includes:
a boil off gas heat exchanger cooling a refrigerant with a boil off gas discharged from the liquefied gas storage tank and transferred to the demander; and
a liquefied gas heat exchanger cooling a refrigerant with a liquefied gas discharged from the liquefied gas storage tank and transferred to the demander, and
the cooling device further includes a refrigerant heat exchanger mutually heat-exchanging a refrigerant downstream of the refrigerant compressor and a refrigerant downstream of the supercooler,
wherein the refrigerant heat exchanger and the liquefied gas heat exchanger are provided in parallel on the refrigerant line, and
the boil off gas heat exchanger and the liquefied gas heat exchanger or the refrigerant heat exchanger are provided in series on the refrigerant line.

10. A ship comprising the gas treatment system according to claim 1.
